(19) United States
(12) Patent Application Publication
(10) Pub. No.: US 2021/0304245 A1
(43) Pub. Date: Sep. 30, 2021

(54) OPERATING SYSTEM PLATFORM FOR EFFICIENT ADVERTISEMENT CONTENT WORKFLOW MANAGEMENT

(71) Applicant: Content Economy Co., Atlanta, GA (US)

(72) Inventor: Elkanah Carnell Reed, Atlanta, GA (US)

(73) Assignee: Content Economy Co., Atlanta, GA (US)

(21) Appl. No.: 17/218,834

(22) Filed: Mar. 31, 2021

Related U.S. Application Data
(60) Provisional application No. 63/002,637, filed on Mar. 31, 2020.

(51) Int. Cl. G06Q 30/02; H04N 21/81; H04N 21/262; H04N 21/2665; G06Q 10/10; G06F 16/27; G06F 9/54

(52) U.S. Cl. CPC G06Q 30/0243; H04N 21/812; H04N 21/26241; H04N 21/2665; G06Q 10/101; G06Q 30/0201; G06F 16/27; G06F 9/547; G06Q 10/105

(57) ABSTRACT

An operating system for discovering, generating, closing a content deal between various teams, measuring content effectiveness and distributing content, for example for product placement advertising. The operating system allows publishers and advertisers to communicate quickly over a single operating system, generate custom line items, media plans, pitches, requests for proposals, and other content, buy and sell content, and drive related workflows and documentation. Workflows are performed on a single operating system and platform. The platform is permission based, and allows a single platform that can be customized and scaled by both publishers and advertisers. Data, documents, media plans, and other content can be created and managed by the operating system.

### CROSS REFERENCE TO RELATED APPLICATIONS

The present application claims the priority benefit of U.S. provisional patent application No. 63/002,637, filed on Mar. 31, 2021, titled “Operating System Platform for Efficient Advertisement Content Workflow Management,” the disclosure of which is incorporated herein.

### BACKGROUND

Product placements in different types of media, such as TV and print ads, are a subset of branded content and forms a very large market. Completing a product placement process by a publisher and advertiser involves numerous workflows by both parties, the challenge of finding each other for an opportunity to conduct business, agreement on the details of the advertising opportunity, generating the content, providing the content through the media, and measuring the effectiveness of the media.

Developing a relationship, generating the content, approval of both parties, and measuring the effectiveness of the relationship for all parties involved in branded content creation and distribution is a very inefficient process. Personal relationships are often required in order to close the deals, in addition to the discovery of opportunities that exist. Further, the use of several different applications and software used by each party to perform different tasks makes it very challenging if not impossible to share digital information in a useful and efficient way. Work is also decentralized between different users that utilize different and incompatible systems.

What is needed is an improved method for publishers and advertisers to identify opportunities, generate content, measure the effectiveness of the media and generally collaborate in different media forms.

### SUMMARY

The present technology, roughly described, is an operating system for generating and distributing content, for example for product placement advertising as well as other forms of branded content. The present operating system allows for publishers and advertisers to communicate smoothly and efficiently over a single platform in a single operating system, generate custom line items, media plans, pitches, request for proposals, and other types of content, buy and sell content, measure content effectiveness, and drive related workflows and documentation.

The present system is a system of record for marketing operations management. The system accesses data from remote data warehouses across silos of an organization. By doing so, seamlessly and efficiently, the present technology brings a traditionally typically separated system with fragmented communication and data into a cohesive platform for both advertisers and publishers to conduct operations within their organization and conduct business with each other. Additionally, advertisers and publishers may still work with their existing and preferred data storage systems while the data is automatically transferred to the present marketing management system for analysis and workflow operations.

Previous systems are decentralized, wherein different users work on different incompatible systems to get work done. The present platform/operating system solves these issues by providing a centralized system for an advertiser and publisher can develop content, communicate with other, track progress, and otherwise collaborate and analyze workflows. All the workflows are performed in the single operating system and platform. The platform is permission based, and allows a single platform to be customized and scaled by both publishers and advertisers. Data, documents, media plans, and other content can be created and managed by the operating system. This provides for uniform access and consistent compatibility by both the advertisers and publishers.

Content is generated from a base of one or more line items. Line items may include one or more fields such as an ID number, name, product ID, booking status, start date, end date the rate type, rate, quantity, cost, frequency, distribution intervals, expiration date, target audience demographics, and other information. One or more line items may form a media plan. A media plan may include a name, budget, currency, start date, end date, expiration date, brand identifier, line item information, and other data. Campaigns, request for proposals, pitches, intellectual property license and other content may be based on the lines and media plans.

The present system has several advantages over the prior art. For example, because the created content is stored and accessible by the same system for both an advertiser and a publisher, less memory and processing power is utilized to discover opportunities, communicate between teams, close content deals, and generate content. In some instances, once all information is aggregated, relationships can be scaled for operational efficiency.

### BRIEF DESCRIPTION OF FIGURES

FIG. 1 is a block diagram of a marketing campaign management system.

FIG. 2 is a block diagram of a server application for providing a marketing campaign platform.

FIG. 3 is a method for providing a marketing campaign platform.

FIG. 4 is a method for creating a marketing campaign.

FIG. 5 is a method for executing a marketing campaign.

FIG. 6 is a method for automatically collecting data for executing a marketing campaign.

FIG. 7 is a method for automatically generating reporting for a marketing campaign.

FIGS. 8A-B illustrate use cases between an advertiser and a publisher.

FIG. 9 is a method for a written request for proposal workflow.

FIG. 10 is a method for a media plan workflow.

FIG. 11 is a method for a campaign workflow.

FIG. 12 is a method for a reporting workflow.

FIG. 13 is a method for time tracking management workflow.

FIGS. 14A-B are a method for an experiential marketing workflow.

FIGS. 15A-B are a method for a product workflow.

FIG. 16 is a method for a user permission workflow.

FIGS. 17A-B are a method for a movie generation workflow.

FIGS. 18A-B are a method for a product workflow.

FIGS. 19A-C are a method for a creator workflow.

FIG. 20A-B are a method for a pitch workflow.

FIG. 21 is a method for content rights management workflow.

FIG. 22 is a method for distribution rights and to and management workflow.

FIG. 23 is a method for a contract signing and legal workflow.

FIG. 24 is a method for an intellectual property management workflow.

FIG. 25 is a method for syndication workflow.

FIG. 26 is a method for a copyright protection workflow.

FIG. 27 is a method for a talent workflow.

FIG. 28 is a method for a work optimization workflow.

FIG. 29 is a screenshot of a dashboard for reporting return on advertisement spend.

FIG. 30 is a screenshot of a dashboard for reporting media plan cash management.

FIG. 31 is a screenshot of a dashboard for reporting views for a particular media plan.

FIG. 32 is a screenshot of a dashboard for reporting advertiser cash management.

FIG. 33 is a screenshot of a master dashboard for an advertiser.

FIG. 34 is a screenshot of a dashboard for reporting publisher team allocation details.

FIG. 35 is a screenshot of a master dashboard for a publisher.

FIG. 36 is a block diagram of an environment for implementing the present technology.

### DETAILED DESCRIPTION

The present technology includes an operating system for generating and distributing content, for example for product placement advertising as well as other forms of branded content. The present operating system allows for publishers and advertisers to communicate smoothly and efficiently over a single platform in a single operating system, generate custom line items, media plans, pitches, request for proposals, and other types of content, buy and sell content, measure content effectiveness, and drive related workflows and documentation.

The present system is a system of record for marketing operations management. The system accesses data from remote data warehouses across silos of an organization. By doing so, seamlessly and efficiently, the present technology brings a typically separated system with fragmented communication and data into a single, cohesive platform for both advertisers and publishers to conduct operations within their organization and conduct business with each other. Additionally, advertisers and publishers may still work with their existing and preferred data storage systems while the data is automatically transferred to the present marketing management system for analysis and workflow operations.

All the workflows are performed in the single operating system and platform. The platform is permission based, and allows a single platform to be customized and scaled by both publishers and advertisers. Data, documents, media plans, and other content can be created and managed by the operating system. This provides for uniform access and consistent compatibility by both the advertisers and publishers.

Content is generated from a base of one or more line items. Line items may include one or more fields such as an ID number, name, product ID, booking status, start date, end date the rate type, rate, quantity, cost, frequency, distribution intervals, expiration date, target audience demographics, and other information. One or more line items may form a media plan. A media plan may include a name, budget, currency, start date, end date, expiration date, brand identifier, line item information, and other data. Campaigns, request for proposals, pitches, intellectual property license and other content may be based on the lines and media plans.

The present system has several advantages over the prior art. For example, because the created content is stored and accessible by the same system for both an advertiser and a publisher, less memory and processing power is utilized to discover opportunities, communicate between teams, close content deals, and generate content. In some instances, once all information is aggregated, relationships can be scaled for operational efficiency.

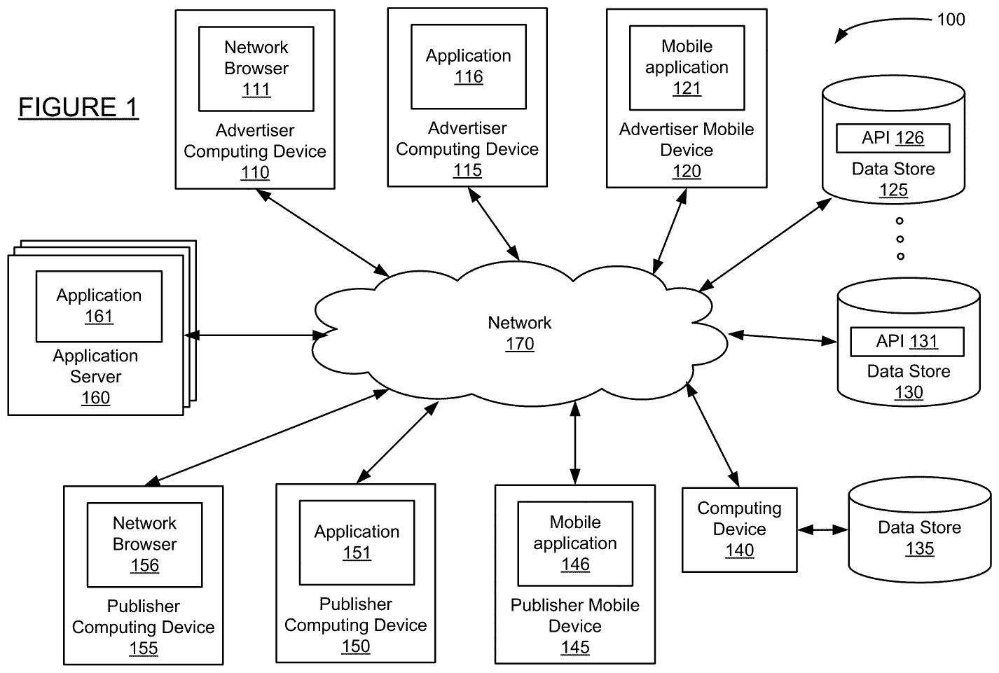

FIG. 1 is a block diagram of a marketing campaign management system. The system of FIG. 1 provinces an operating system for generating and distributing content. System 100 of FIG. 1 includes advertiser computing device 110, advertiser computing device 115, advertiser mobile device 120, data store 125, data store 130, data store 135, computing device 140, publisher mobile device 145, publisher computing device 150, publisher computing device 155, application server 160, and network 170.

Advertiser computing devices 110-120 may be associated with one or more advertiser roles in marketing campaign management system provided by the application server 160. Each of devices 110-120 may be used by one or more users having roles in a platform provided by application server 160. The users associated with advertiser computing devices 110-120 may access the platform provided by server 160 on their particular device, and work on various tasks and operations through their device in the platform provided by server 160.

Computing device 110 may include network browser 111 stored in device memory and executed by one or more processors. In some instances, network browser 111 may receive content pages and other data from a remote server 160, and provide the content pages to a user through an output of computing device 110. The content pages may provide interfaces, provide output, collect input, and otherwise communicate with a user through computing device 110 and communicate with application 161 over network 170, as part of implementing the present technology discussed herein. Computing device 110 can be implemented as a desktop computer, workstation, or some other computing device.

Computing device 115 may include application 116 stored in device memory and executed by one or more processors. In some instances, application 116 may receive data and from a remote server 160, process the data and render output from the raw and processed data, and provide the output to a user through an output of computing device 110. The application can provide interfaces, provide output, collect input, and otherwise communicate with a user through computing device 110 and communicate with application 161 over network 170, as part of implementing the present technology discussed herein. Computing device 110 can be implemented as a desktop computer, workstation, or some other computing device.

Mobile device 120 may include a mobile application 121. Mobile application 121 may provide interfaces, provide output, and receive input as part of implementing the present technology as discussed herein. Mobile device 120 may be implemented as a laptop, cellular phone, tablet computer, chrome book, or some other machine that is considered a “mobile” computing device.

Data stores 125-130 may store data related to advertiser information and publisher information. The data may include viewership, expense, income, user accounts, media plans, and other data associated with an advertiser, publisher, or marketing campaign. Data store 125 includes application program interface (API) 126. API 126 may include code that resides inside or outside of data store 125 that can communicate with other entities, manage and store data in data store 125, retrieve, aggregate, process, and transmit data within data store 125, or to and from server application 161 of application server 160. API 131 may also collect, store, process, aggregate, retrieve, and transmit data within data store 130 to application server 161, including any data related to an advertiser, publisher, marketing campaign, or other data relevant to the technology discussed herein.

Data store 135 may also include data related to an advertiser, publisher, marketing campaign, or other data related to content discussed herein, which may be retrieved from computing device 140 and provided to server application 161. In some instances, data from data store 135 may be accessed in a particular format, such as a comma separated value (CSV) file, json file, XML file, or some other type of file, and provided to server application 161 to be imported for processing and reporting by the campaign marketing platform implemented by application server 160 and application 161.

Computing device 155 includes network browser 156 and is similar to and operates roughly in the same manner as computing device 110 that includes network browser 111, except computing device 155 is used by a publisher instead of an advertiser. Computing device 150 includes application 151 and is similar to and operates roughly in the same manner as computing device 115 that includes application 116, except computing device 150 is used by a publisher instead of an advertiser. Mobile device 145 includes mobile application 146 and is similar to and operates roughly in the same manner as mobile device 120 having mobile application 121, except mobile device 145 is used by a publisher instead of an advertiser.

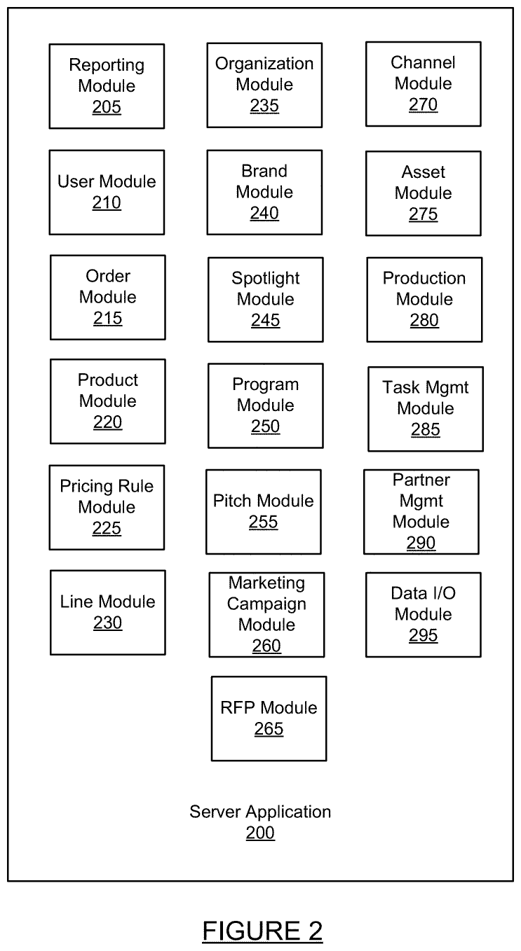

Application server 160 may include application server 161. Application 161, which may be a single application or distributed application, includes a software that implements the advertising and campaign management platform functionality and operations discussed herein. Server application 161 is discussed in more detail with respect to block diagram of FIG. 2.

Application server may include one or more physical or logical machines and can store and execute application 145. Application 145 may be implemented as one or more programs, distributed code, objects, or other software that implements the technology and functionality described herein.

Network 170 may implement communication between computing devices, data stores, and servers in FIG. 1. Network 130 may include one or more networks suitable for communicating data, including but not limited to a private network, public network, the Internet, an intranet, a wide area network, a local area network, a wireless network, a Wi-Fi network, a cellular network, and a plain old telephone service (POTS).

In some instances, devices 110-120 and 145-155 may communicate with application server 160 over network 170. Data stores 125-135 may communicate directly or indirectly with application server 161 over network 170. In some instances, each of the machines 110-160 may communicate with each other as well as other machines over one or more networks 170.

FIG. 2 is a block diagram of a server application for providing a marketing campaign platform. Server application 200 of FIG. 2 provides more detail for application 161 of FIG. 1. Server application 200 includes modules 205-295, which may be stored in memory and executable by one or more processors on one or more application servers, which have functionality that implement the technology discussed herein. Modules are exemplary, and additional or fewer modules may be implemented than those illustrated in server application 200 of FIG. 2. Additionally, some modules may be implemented as distributed modules, some modules may be combined, some modules may be divided into multiple modules, and otherwise implemented in a slightly different way than that illustrated in FIG. 2, based at least on design preferences.

Reporting module 205 may report Ron process data to one or more advertiser and publisher roles. The reporting module may manage dashboards, email notifications, text message notifications, and other communications and interfaces to provide information to users regarding aspects of advertiser operations, publisher operations, a campaign, or other aspects of an advertisement campaign as discussed herein.

User module 210 may be used to manage user accounts, create, modify, update and delete account data, associate users with a particular brand, provide user information requested by other users, and create and manage identities for each user.

Order module 215 may be used to manage orders. In some instances, in order may be associated with a publisher, and a media plan may have many orders. In order may be used as a tool for holding a product.

Product module 220 may be used to create, revise, update and delete one or more products within the advertising platform. Different aspects and features of a different product may all be handled and managed by product module 220.

Pricing rule module 225 may be used to set dynamic pricing for a particular product. In some instances, a product may have different and sometimes complicated pricing parameters based on factors such as geography, date and time, and other associations of a particular product.

Line module 230 may be used to create, revise, update, and delete a particular line item. In some instances, a line may be a product that is approved to be included into a media plan. Line module 230 handles management of a line once it is created.

Organization module 235 may be used to create, update, delete, and retrieve one or more organizations. An organization may be associated with either a publisher or an advertiser, and a particular user type may depend on the organization type.

Brand module 240 may be used to create, retrieve, update and delete media plans. The brand module may also be used to assign users of different roles to a particular brand.

Spotlight module 245 may be used to prepare one or more items to provide in response to a search request. The items provided may be “spotlighted” by providing them strategically within a search results list. Spotlight module 245 may update and revise spotlighted items for organizations, roles, or individual users based on history of the particular user, organization, or role.

A program module 250 may be used to generate a program. In some instances, a publisher creates a channel, a channel may create a show, and a show me create a program. An example of a program may include a particular episode of a particular season of the show. Once created, products can be added to a program. Marketing campaigns generated on the present platform existing media to be watched or experienced. An example of a program is the Super Bowl, and a product for the Super Bowl program may include integration of a brand into a halftime show. In this instance, the product may become a line when a particular customer indicates that they will purchase the integration of their brand into the halftime show.

A pitch module 255 may be used to generate, modify, retrieve, and delete a particular pitch. A pitch, in some instances, may be considered a presentation that sets forth a solution for exposing a brand to an audience, or otherwise provide an audience solution. A pitch may or may not at a product, and may be sent by a publisher to an advertiser to brainstorm, and may be revised back and forth between parties before it is approved.

A marketing campaign module may be used to prepare, modify, retrieve, and delete marketing campaigns. Marketing campaigns may be associated with one or more products, and once approved indicate what is to be performed for a particular brand.

A request for proposal (RFP) module manages RFPs generated within a particular platform. An RFP may be provided by a publisher or an advertiser, and may invite a proposal from one or more parties wishing to do business with the generator at the RFP.

A channel module may be used to create, retrieve, update or delete one or more channels. Channel may be used to create a show, and may be managed by one or more roles.

Asset module 275 may manage the workflow of asset management. In some instances, a digital asset can be connected to task management module. Examples of assets include cash, products, and other items.

Correction module 280 may be used to manage an end and workflow for producing elements of the campaign management system. Correction module 280 may be used, for example, to add tasks, images, and other elements to a production.

Task management module 285 may be used to create, update, delete, and retrieve tasks within the platform provided herein. The test may be related to one or more channels, programs, line items, marketing campaigns, media plans, and other aspects of the campaign management system.

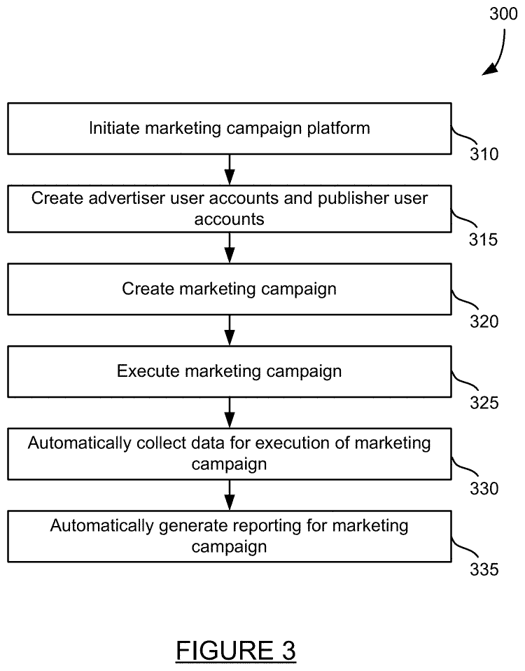

FIG. 3 is a method for providing a marketing campaign platform. The method of FIG. 3 begins with initiating a marketing campaign platform at step 310. Initiating the marketing campaign platform may include starting the platform, creating templates for different user accounts, updating APIs and other code to be implemented in other machines, and other operations.

Advertiser user accounts and publisher user accounts are created at step 315. The user accounts make be created with different roles for the advertiser in the publisher. For example, an advertiser user account may include a senior VP of advertising, and multiple other roles that report to the senior role. Similarly, the publisher user accounts may include a senior-level publisher account and multiple junior level accounts that report to the senior-level account. All the user accounts may be created through interaction with application 161 it may be stored locally on one or more servers 160 or remotely to a database in communication with server 160.

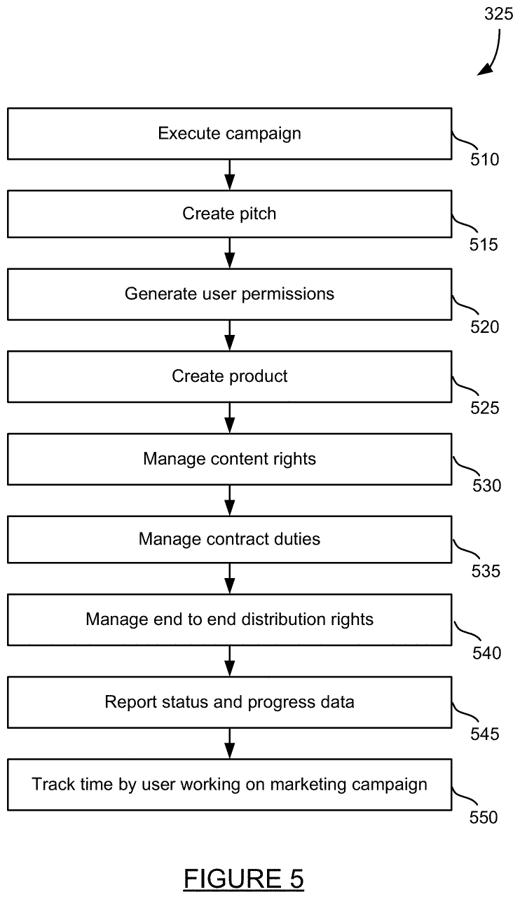

A marketing campaign is created at step 320. Creating a marketing campaign include creating a product, media plan, and ultimately getting approval for these elements. Creating a marketing campaign is discussed in more detail to respect to the method of FIG. 5.

The marketing campaign may be executed at step 325. Executing the marketing campaign may include generating advertisements, placing advertisements in media, transferring money three of the campaign, tracking the money made during the campaign, and performing other tasks. Executing a marketing campaign is discussed in more detail below with respect to the method of FIG. 5.

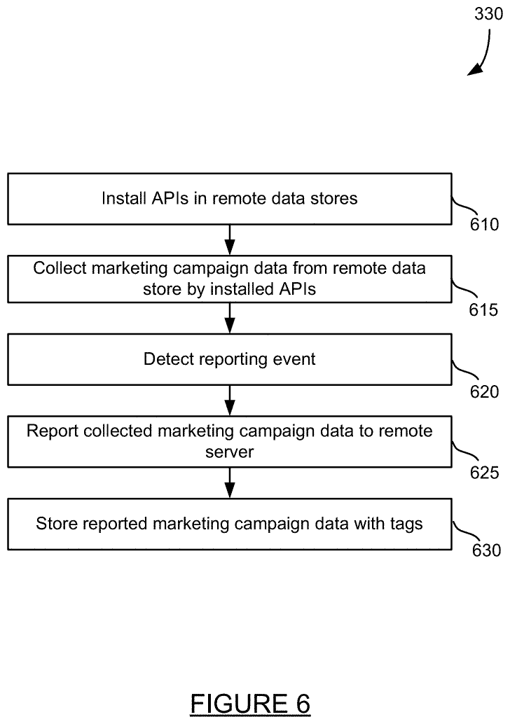

Data is automatically collected by the present system for execution of the marketing campaign at step 330. The data may automatically be collected from one or more external machines that store data associated with the marketing campaign, such as cash spent, revenue, viewership in media, and other data. Automatically collecting data by the present system is discussed with respect to the method of FIG. 6.

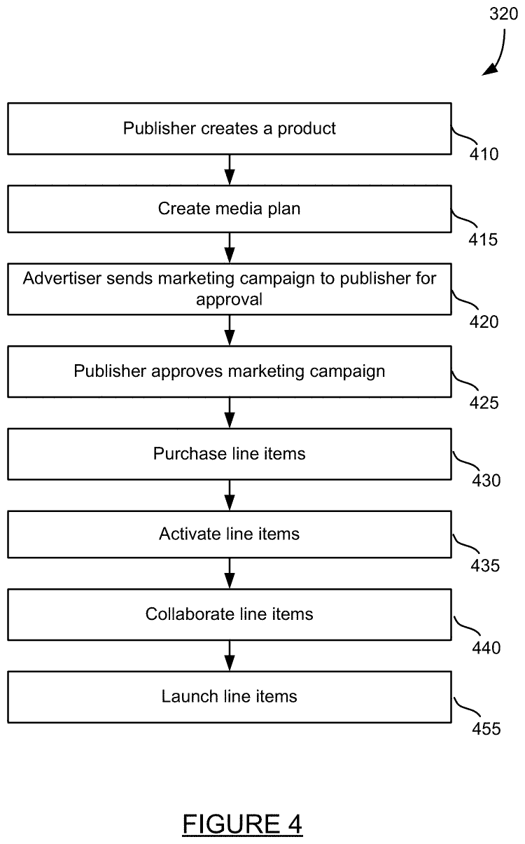

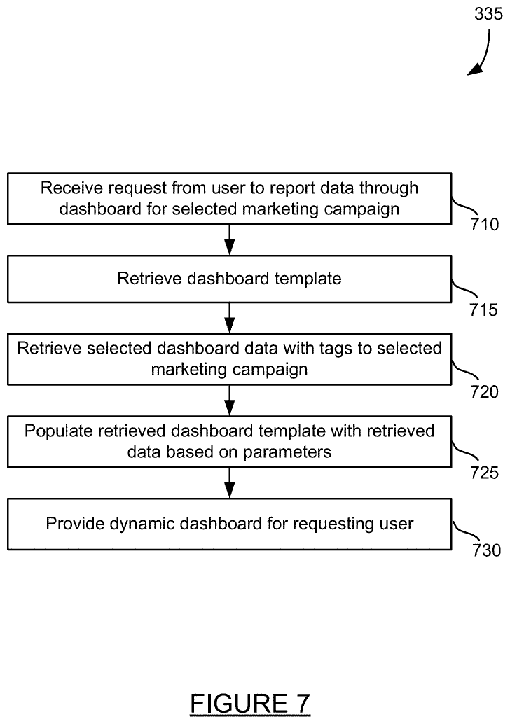

In some instances, data may also be collected manually by the present system for execution of a marketing campaign. In this instance, data may be organized into some type of data format, such as a CSV file, manually uploaded to the present platform. Reporting is automatically generated for the marketing campaign at step 335. Reporting may include providing data through one or more dashboard interfaces designed for either an advertiser or a publisher. More details for automatically generating reporting for a marketing campaign are discussed in more detail with respect to the method of FIG. 7. FIG. 4 is a method for creating a marketing campaign. The method of FIG. 4 provides more detail for step 320 of the method of FIG. 3. First, a publisher creates a product at step 410. The product may include a product for sale to a consumer, such as household product, a service, or something else for sale. The media plan is created at step 415. The media plan may indicate where, when, and how often an advertisement will be run in media for the product being sold.

An advertiser can send a marketing campaign to the publisher for approval at step 420. The marketing campaign may be generated by the advertiser for the product using the media plan. The publisher may approve marketing campaign at step 425. In some instances, a publisher may initially not approve of a marketing campaign, and provide feedback to the advertiser. In this instance, the advertiser may change or rework the marketing campaign and send the reworked marketing campaign to the publisher for approval. The advertiser and publisher may conduct multiple rounds of potential approval until the publisher approves the marketing campaign.

Line items may be purchased through the platform at step 430. Once the publisher approves the marketing campaign, line items, including actions, task, or other aspects of marketing campaign, can be purchased by the publisher from the advertiser through the platform provided by the present system. Line items may then be activated by the advertiser, and the advertiser and publisher may then collaborate on the line items at step 440. After collaboration, line items may be launched by the advertiser at step 455.

FIG. 5 is a method for executing a marketing campaign. The method of FIG. 5 provides more detail for step 325 of the method of FIG. 3. The campaign may be executed at step 510 a pitch may be created at step 515. The pitch may include aspects of the campaign that are beneficial to the recipient and/or the audience listening to the pitch. User permissions may be generated at step 520. User permissions will indicate which users from the advertiser and publisher can be different portions of the marketing campaign. A product is created at step 525, and content rights may be managed at step 530. The contract duties may be managed at step 535. End to end distribution rights may be managed at step 540. The status and progress data within the marketing campaign may be reported at step 545, for example through one or more dashboards. Time of users working on a marketing campaign may be tracked at step 550. In some instances, users may track their time when logged in to the present marketing campaign management system.

FIG. 6 is a method for automatically collecting data for executing a marketing campaign. The method of FIG. 6 provides more detail for step 330 of the method of FIG. 3. First, APIs may be installed in remote data stores at step 610. Marketing campaign data may then be collected from the remote data stores by the installed APIs at step 615. Campaign data may be collected when it is received by the data store, periodically, or based on some other event. Collecting a marketing campaign data may include stowing the data into tables that are ready to transmit to one or more remote application servers at a later time.

A reporting event may be detected at step 620. The reporting event may be a periodic event, a request from a remote server, or some other event. Once reporting event is detected, the collected marketing campaign data may be reported to the remote server at step 625. The marketing campaign data may be sent as a stream of data, timeseries data, a table, json data, a csv file, or in some other format. The reported marketing campaign data is then stored by the receiving server at step 630. The received data then may be updated with tags, either by the receiving server or the API that store the data at the remote data store.

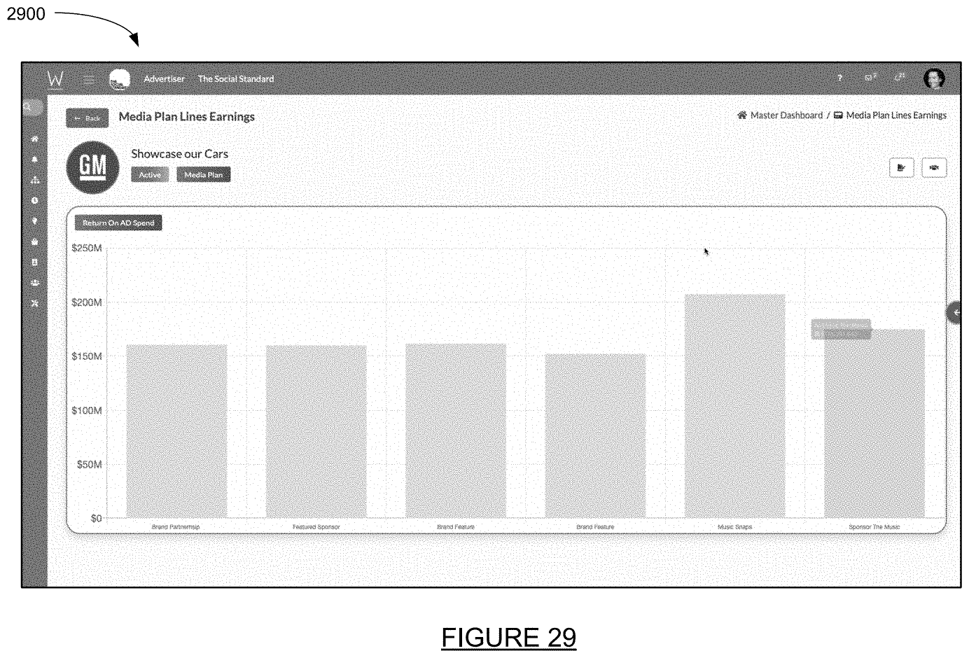

FIG. 7 is a method for automatically generating reporting for a marketing campaign. The method of FIG. 7 provides more detail for step 335 of the method of FIG. 3. First, a request is received from user to report data through a dashboard for a selected marketing campaign at step 710. A dashboard template is then retrieved at step 715. The dashboard template may be received from one of several store templates and may be related to the organization, information requested, geographic location of the requester, and other data. The selected dashboard data with tags to the selected marketing campaign is retrieved at step 720. The retrieved dashboard template is then populated with the retrieved data based on one or more parameters at step 725. The parameters may be associate with user preferences, user roles and permissions, and other parameters. A dynamic dashboard is and provided to the requesting user at step 730. The dashboard may include up-to-date information that is dynamically updated based on most recent data available. Examples of dashboards provided by the present system are discussed with respect to FIGS. 29-35.

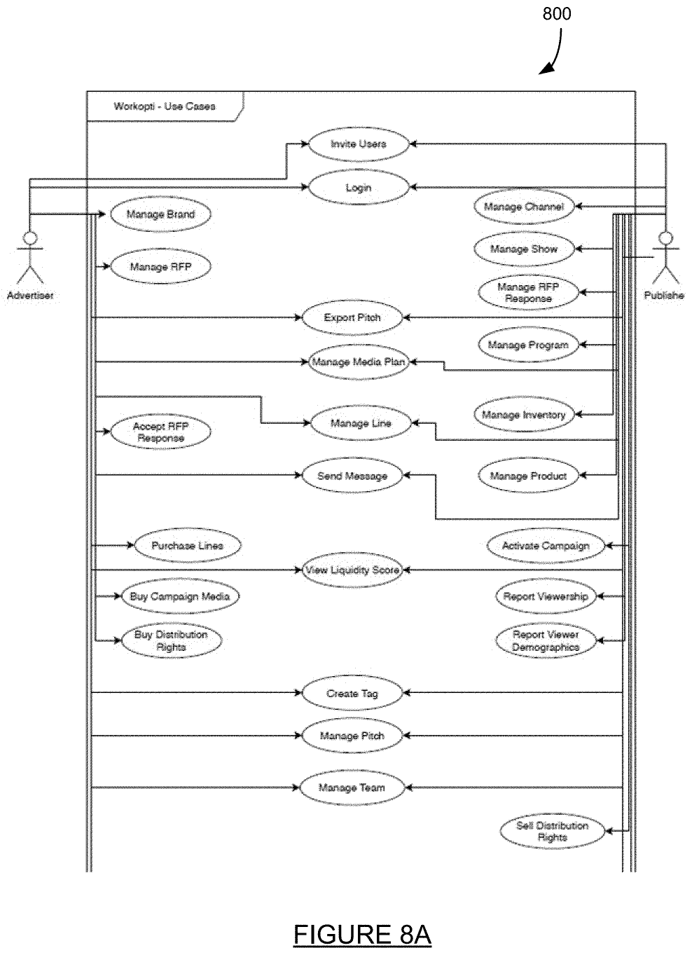

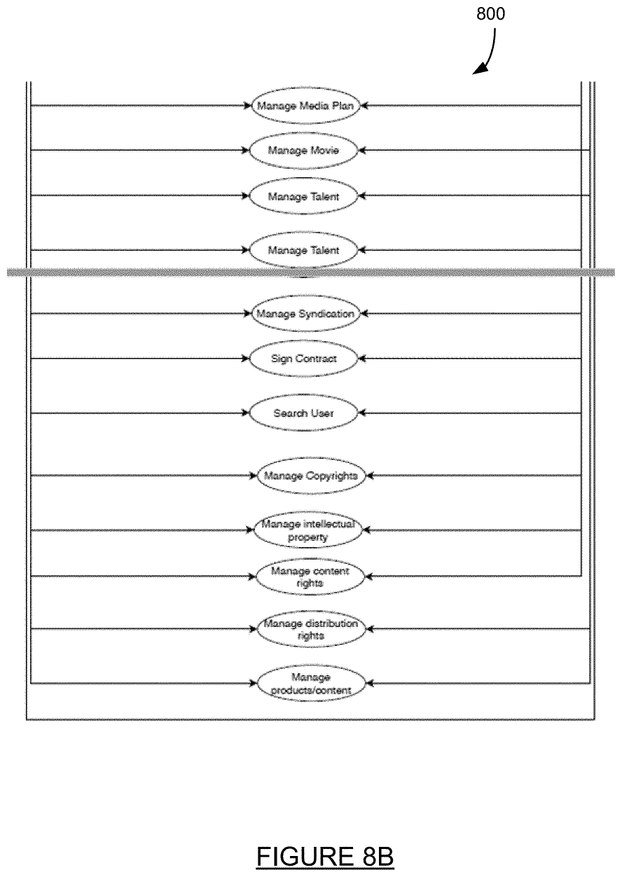

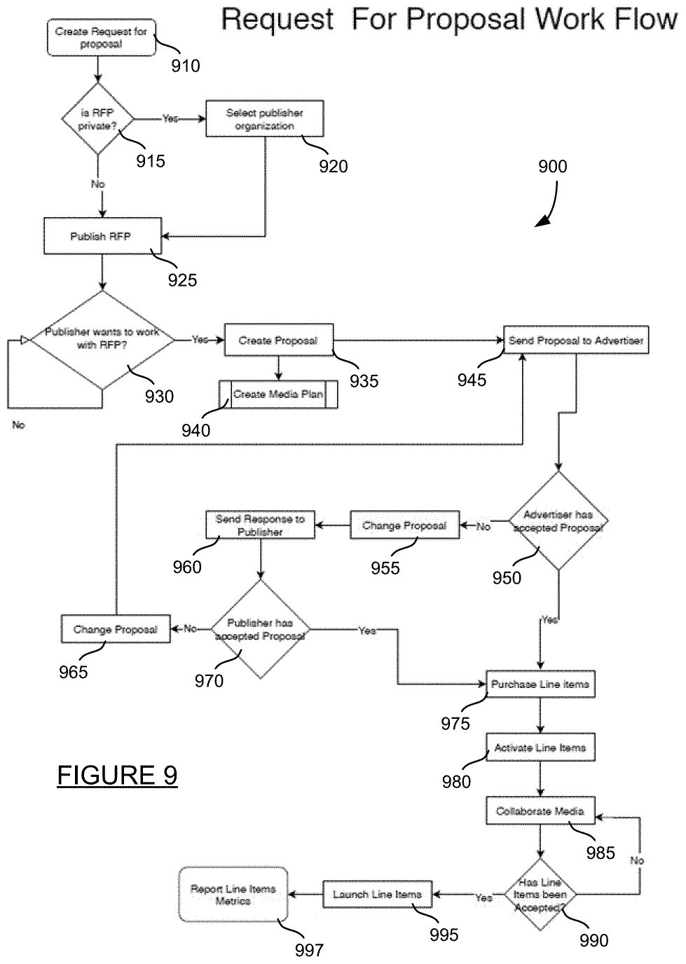

FIGS. 8A-8B illustrate use cases between an advertiser and a publisher. FIG. 8A illustrates an advertiser and a publisher and some of the workflows that happened between them. For example, each team at an advertiser and publisher organization may invite users to use the system or platform. An advertiser and publisher may also participate login to access their accounts with the present system. An advertiser may manage brands, manage a request for a proposal, accept a request for proposal response, build a media plan, purchase line items, buy campaign media, and buy distribution rights. A publisher may manage a channel, manage a show, manage a request for proposal response, manage a program, manage inventory, manage a product, buy intellectual property rights, activate a campaign, report viewership, report viewer demographics, and sell distribution rights. Also illustrated in FIG. 8A, an advertiser and publisher may both export a pitch, manage media plans, manage a line item, send messages, view liquidity scores, create tags, manage a pitch, and manage a team.

In FIG. 8B, an advertiser and a publisher may both manage media plans, movies, talent, syndication, copyrights, intellectual property, content rights, distribution rights, and products or content. A publisher and advertiser may also sign contracts and search for users.

FIGS. 8-28 describe workflows performed at least in part by application server 161. Several steps may be implemented through one or more interfaces, such as for example steps that receive notice or input that a process has started or begun. Several steps may include computational operations. The technical implementations of the workflows solve the technical problem of accomplishing a product placement in a channel of media such that a publisher and advertiser can efficiently communicate with each other and scale their operations.

FIG. 3 is a method for a written request for proposal workflow. First, a request for a proposal is created at step 310. A determination is made as whether the request for proposal is private at step 915. If the request is private, a publisher organization with which to share the proposal with is selected at step 920, and the request for proposal is published to that publisher at step 925. In some instances, if a request is private, it is only published to the selected publishers.

After publishing a request for proposal, a determination is made as to whether a publisher wants to work with a request for proposal at step 930. If a publisher does not want to work with the request, the method of FIG. 9 remains at step 930. If a publisher does want to work with a request for proposal, the proposal is created at step 935. A media plan can be created at step 940, and the proposal may be sent to the advertiser by the publisher at step 945.

A determination is made as whether an advertiser has accepted a proposal at step 950. If the advertiser has not accepted the proposal, the proposal may be changed at step 955 and the response may be sent to the publisher by the advertiser at step 960. If the publisher accepts the changed proposal, FIG. 9 continues to step 975. If a publisher has not accepted the proposal, the proposal may be changed at step 965 and the method continues to step 945.

If a proposal is accepted at either step 950 or step 970, line items are purchased at step 975. Line items may be activated at step 980 and media collaboration occurs at step 985. A determination is made as to whether a line item has been accepted at step 990. If no line item is accepted, the method returns to step 985. If a line item has been accepted, line items are launched at 995 and the line item metrics are reported at step 997.

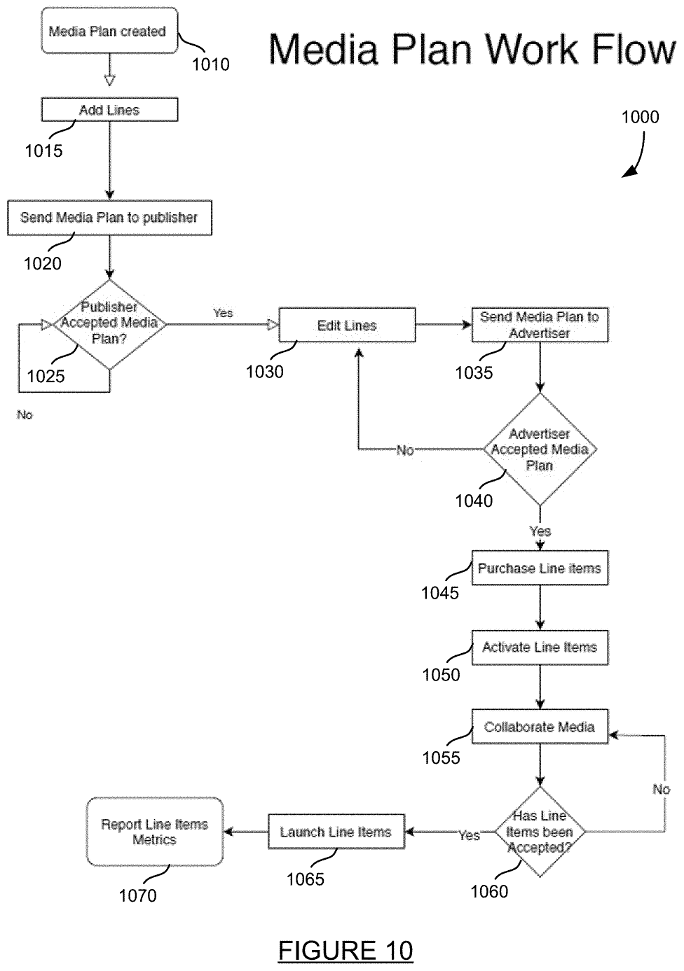

FIG. 10 is a method for a media plan workflow. A media plan is created at step 1010. In some instances, creating a media plan may be done based on a template, form, or other predetermined format for the media plan. In some instances, a media plan may be created for a new channel of content or otherwise created from scratch. Creating a media plan may include adding line items at step 1015. After adding one or more line items, the media plan may be sent to a publisher at step 1020.

A determination is made as to whether a publisher is accepted a media plan at step 1025. If the publisher has not accepted the plan, the method of FIG. 10 remains at step 1025. If the publisher has accepted the plan, line items may be edited at step 1030 and the media plan may be sent to an advertiser at step 1035. A determination is made as to whether an advertiser accepts the media plan at step 1040. If the advertiser does not accept the media plan, the method of FIG. 10 returns to step 1030 to further edit the lines of the media plan. If the advertiser does accept the media plan, line items may be purchased at step 1045 and activated at step 1050.

Media collaboration may occur at step 1055. A determination is then made as to whether line items have been accepted at step 1060. If line items have not been accepted, the method of FIG. 10 returns to step 1055 for further media collaboration. If line items have been accepted, line items are launched at step 1065 and line item metrics are reported at step 1070.

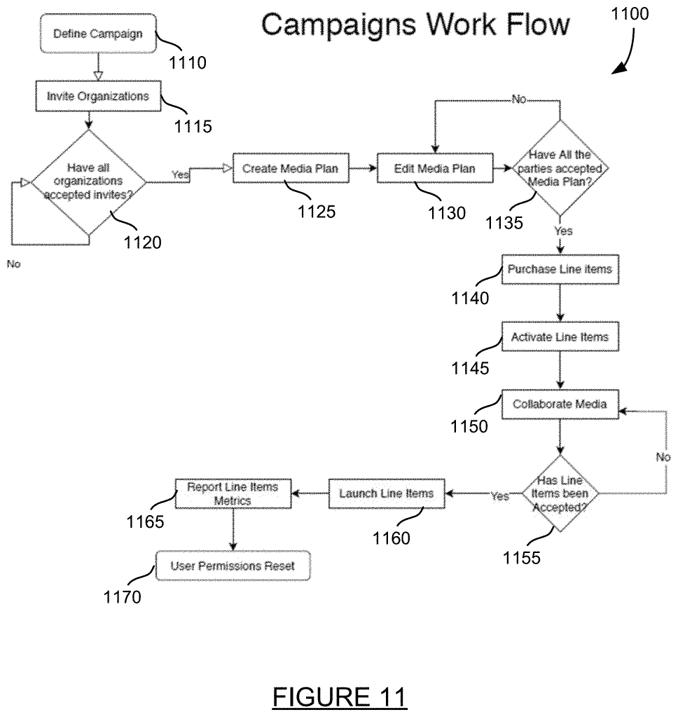

FIG. 11 is a method for a campaign workflow. The campaign is defined at step 1110. Organizations are invited at step 1115, and a determination is made as to whether all organizations have accepted the invite at step 1120. If any organizations have not accepted the invite, the method remains at step 1120. If all organizations have accepted the invite, a media plan is created at step 1125. The media plan may be edited at step 1130, and a determination is made as whether all the parties have accepted the media plan at step 1135. If not all parties have accepted the media plan, the method returns to step 1130 where the media plan is further edited. Once the parties have accepted the plan, line items are purchased at step 1140 and are then activated at step 1145.

Media collaboration occurs at step 1150. A determination is then made as to whether line items have been accepted at step 1155. If the line items have not been accepted, the media is further collaborated at step 1150. If the line items have been accepted, line items are launched at step 1150 and line item metrics are reported at step 1165. User permissions are then reset at step 1170.

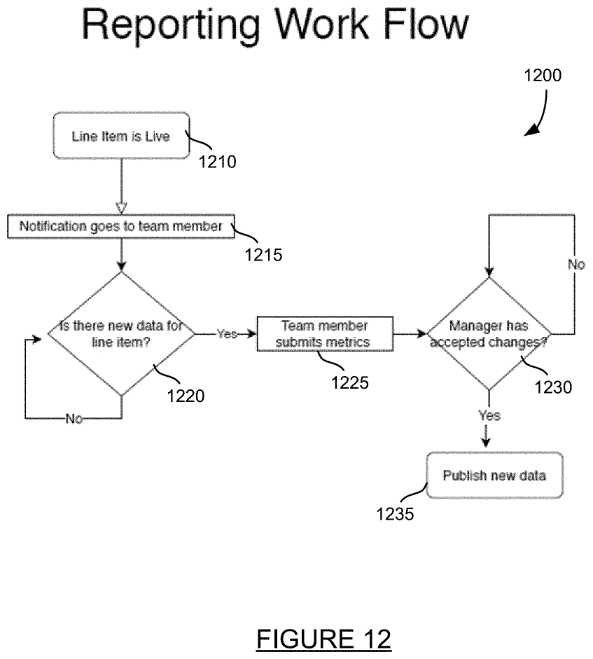

FIG. 12 is a method for reporting a workflow. A line item goes live at step 1210. The notification then goes to a team member regarding the live line item at step 1215. A determination is then made as to whether there is a new data for the line item at step 1220. If there is no new data, the method remains at step 1220. If there is new data for the line item, a team member submits metrics at step 1225. A determination may then be made at step 1230 as to whether a manager has accepted the changes. If a manager has not accepted the changes, the method remains at step 1230. If a manager has accepted the changes, the new data is published at step 1235.

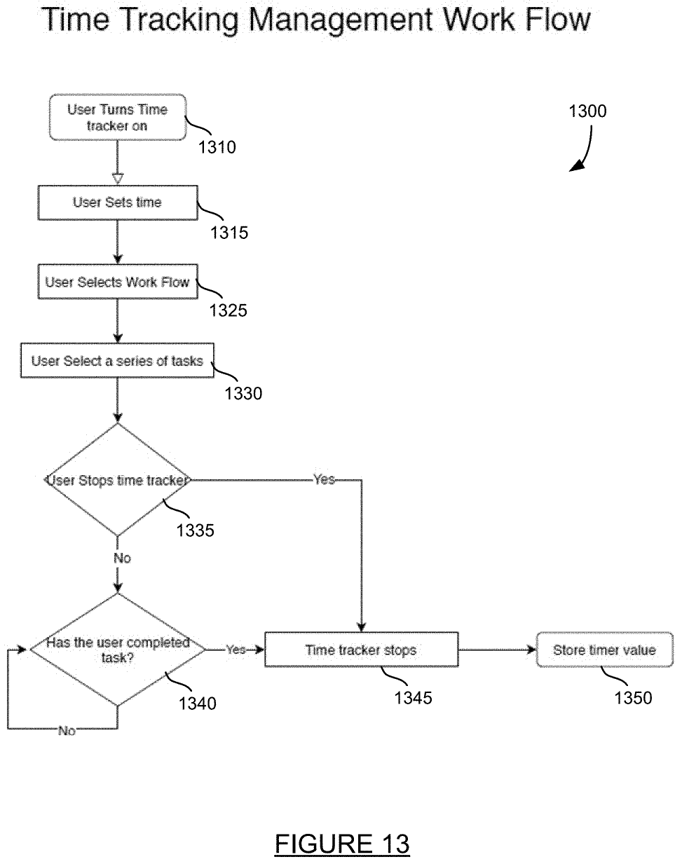

FIG. 13 is a method for time tracking management workflow. First, a user turns a time tracker on at step 1310. The user sets the time at step 1315 and selects a workflow at step 1325. A user may then select a series of tasks at step 1330. A determination is made as to whether a user stops a time tracker at step 1335. If a user does stop a time tracker, the method of FIG. 13 continues to step 1345 where the time tracker stops. If a user does not stop the time tracker, a determination is made as whether the user has completed the task at step 1340. If the user has not completed the task, the method remains at step 1340 or returns to step 1335. Once the user has completed a task, the time tracker stops at step 1345 and a timer value is stored at step 1350.

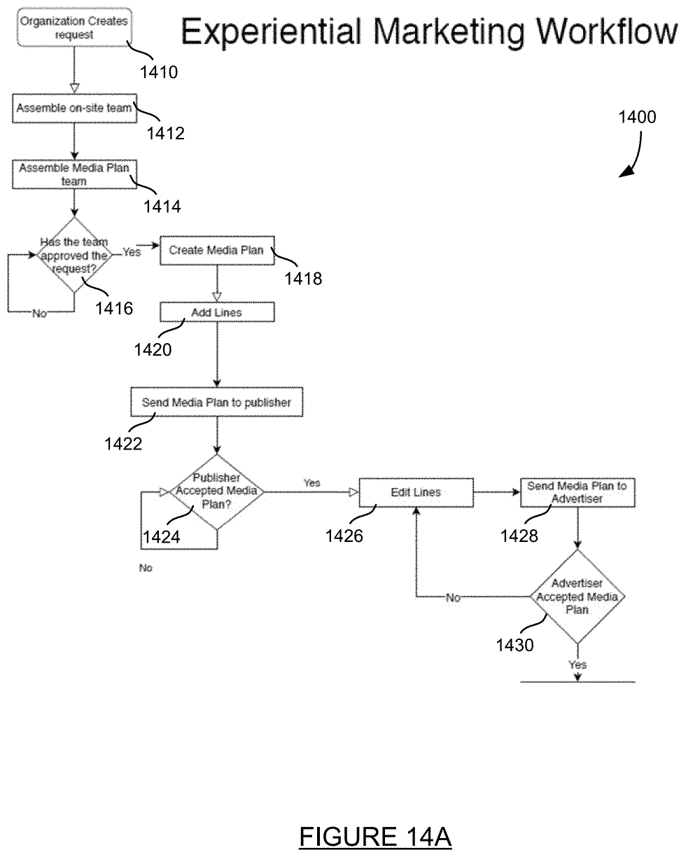

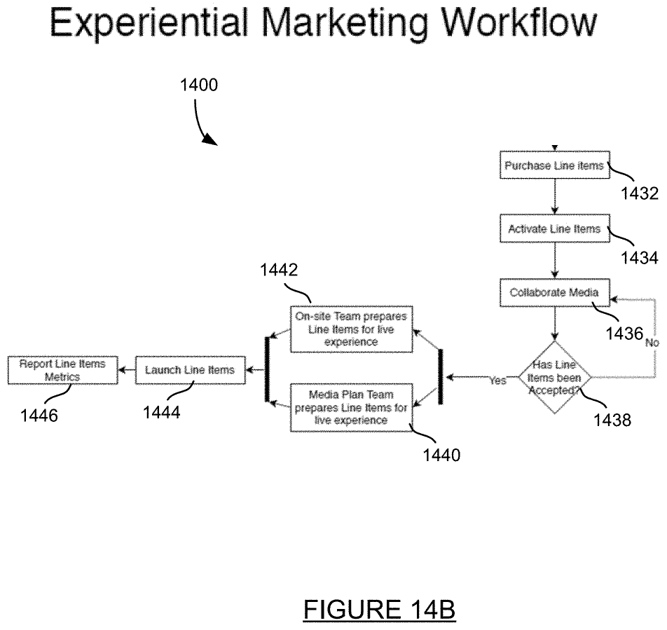

FIGS. 14A-8B are a method for an experiential marketing workflow. An organization creates a request at step 1410. An on-site team is assembled at step a 12. A media plan team can be assembled at step 1414. A determination is then made as to whether the team has approved the request at step 1416. If the team has not approved the request, the method of FIG. 14A remains at step 1416. If the team has approved the request, a media plan is created at step 1418. Line items may be added to the created media plan at step 1420 and the media plan may be sent to a publisher at step 1422. A determination is made as whether the publisher accepts the media plan at step 1424. If the publisher has not accepted the media plan, the method of FIG. 14A remains at step 1424. If the publisher has accepted the media plan, lines may be edited at step 1426 and the media plan is then sent to an advertiser at step 1428. A determination is then made as to whether the advertiser accepts the media plan at step 1430. If the advertiser does not accept the media plan, the method of FIG. 14 returns to step 1426. If the advertiser does accept the media plan, the method of FIG. 148 continues to step 1432 of FIG. 14B.

In FIG. 14B, line items are purchased at step 1432. Line items may be activated at step 1434, and media can be collaborated at step 1436. A determination is made as whether a line item has been accepted at step 1438. If the line item has not been accepted, the method returns to step 1436. If the line item has been accepted, an on-site team prepares the line item for live experience at step 1442 and the media plan team prepares line item for live experience at step 1440. After preparing line items for a live experience, line items are launched at step 1444 and line item metrics are reported at step 1446.

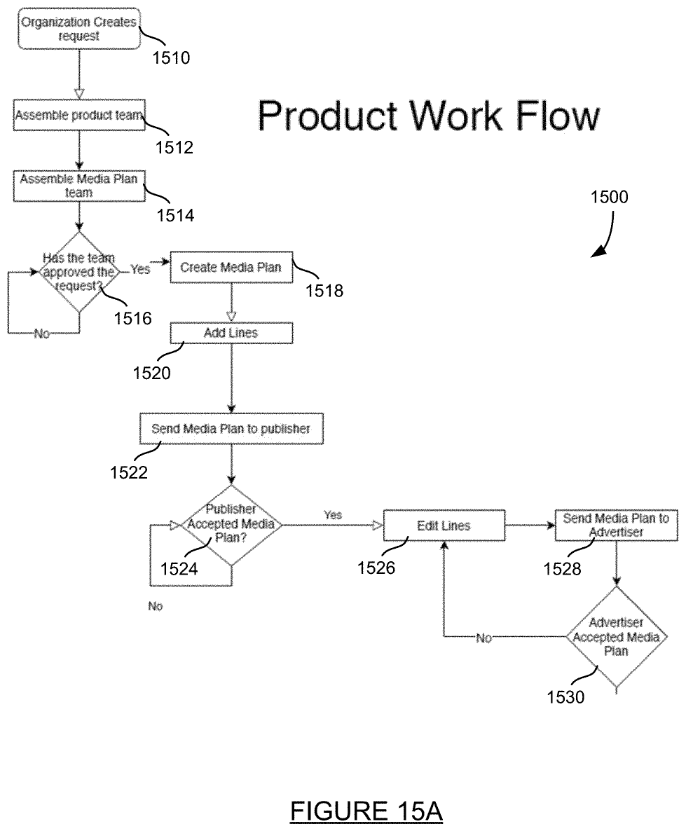

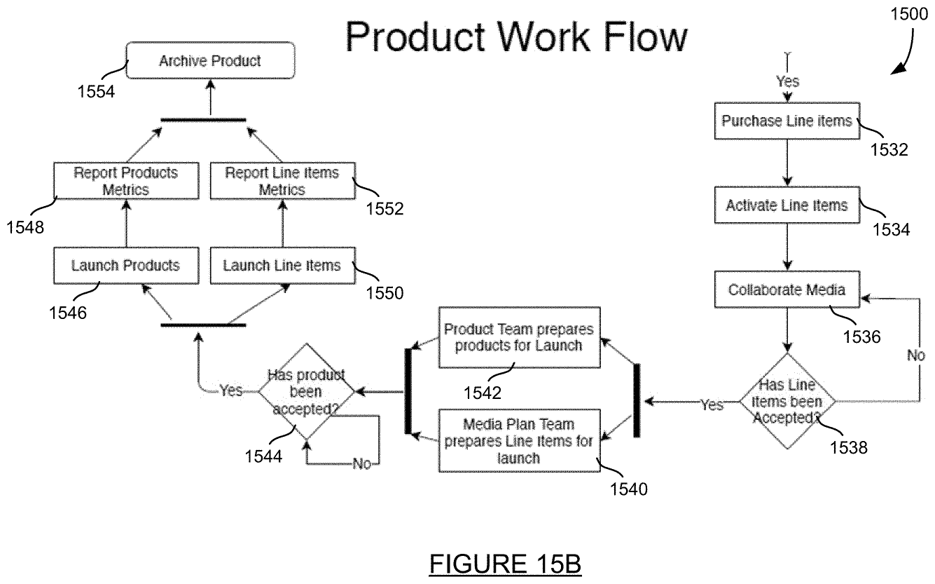

FIGS. 15A-9B are a method for a product workflow. A request is created by an organization at step 1510. The product team is assembled at step 1512 and a media plan team is assembled at step 1514. A determination as to whether the team has approved the request is made at step 1516. If the team has not approved the request, the method of FIG. 15A remains at step 1516. If the team has approved the request, a media plan is created at step 1518, and line items are added to the media plan at step 1520.

A media plan is sent to a publisher at step 1522. A determination is made as to whether the publisher accepts the media plan at step 1524. If the publisher does not accept the media plan, the method of FIG. 15 remains at step 1524. If the publisher does accept the media plan, the line items are edited at step 1526 and then the media plan is sent to an advertiser at step 1528. A determination is then made as to whether the advertiser accepts the media plan at step 1530. If the advertiser does not accept the media plan, lines are further edited at step 1526. If the advertiser does accept the media plan, the method of FIG. 15A continues to step 1530 in the method of FIG. 15B.

In the method of FIG. 15B, line items are purchased at step 1532 and activated at step 1534. Media collaboration occurs at step 1536. A determination is made as whether the line items have been accepted at step 1538. If the line items have not been accepted, the method of FIG. 15B returns to step 1536. If the line items have been accepted, then a media plan team prepares line items for launch at step 1540 and a product team prepares the products for launch at step 1542.

After preparing for launch, a determination is made as whether the product has been accepted at step 1544. If the product has not been accepted, the method of FIG. 15B remains at step 1544. If the product has been accepted, products are launched at step 1546 and product metrics are reported step 1548, and in parallel line items are launched at step 1550 and line item metrics are reported at step 1552. After reporting line item metrics and product metrics, a product is archived at step 1554.

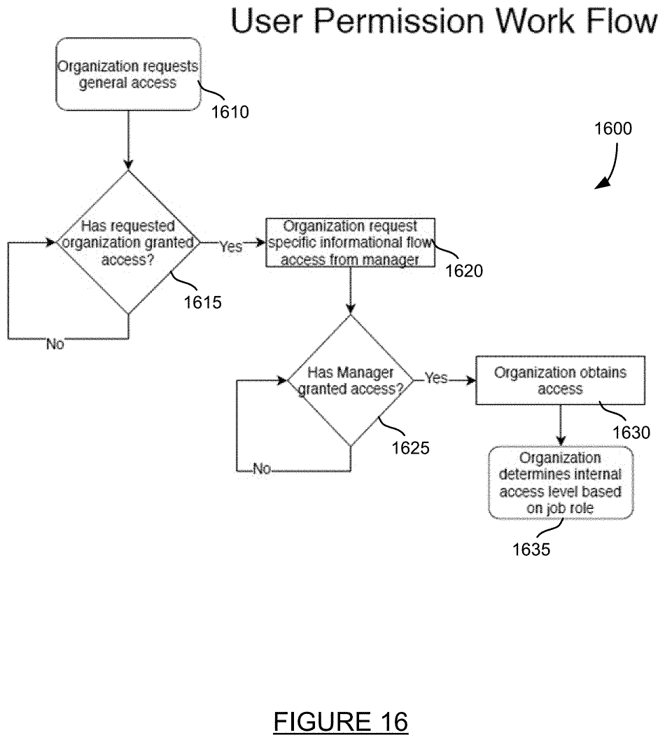

FIG. 16 is a method for a user permission workflow. An organization may request general access at step 1610. A determination is made as to whether the requested organization has been granted access at step 1615. If the requested organization has not been granted access, the method of FIG. 16 remains at step 1615. If the organization has been granted access, the organization requests specific information flow access from a manager at step 1620. A determination is made as to whether a manager has been granted access at step 1625. If the manager has not been granted access, the method of FIG. 16 remains at step 1625. If the manager has been granted access, the organization obtains access at step 1630. The organization determines internal access level based on job role at step 1635.

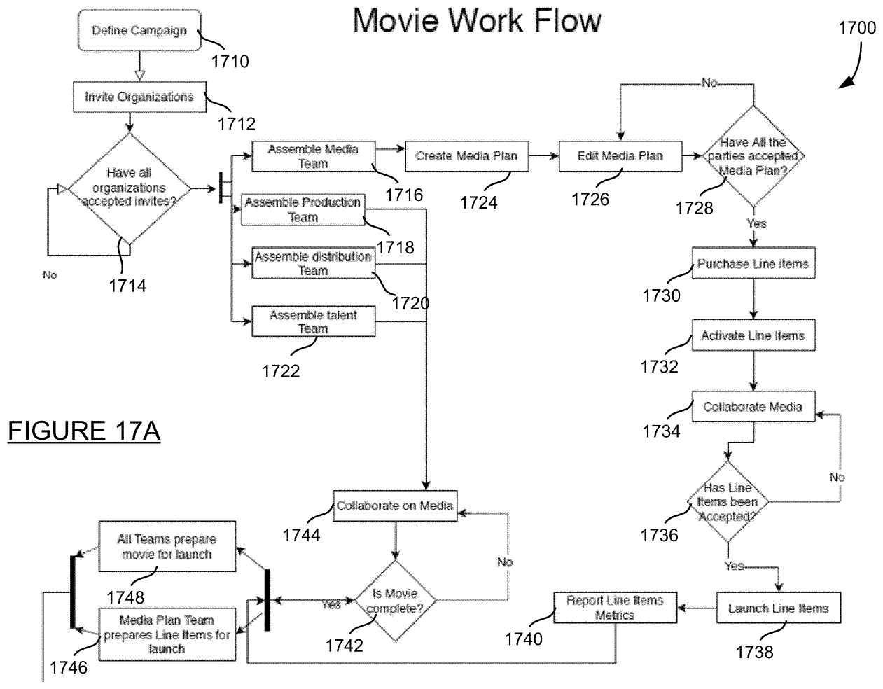

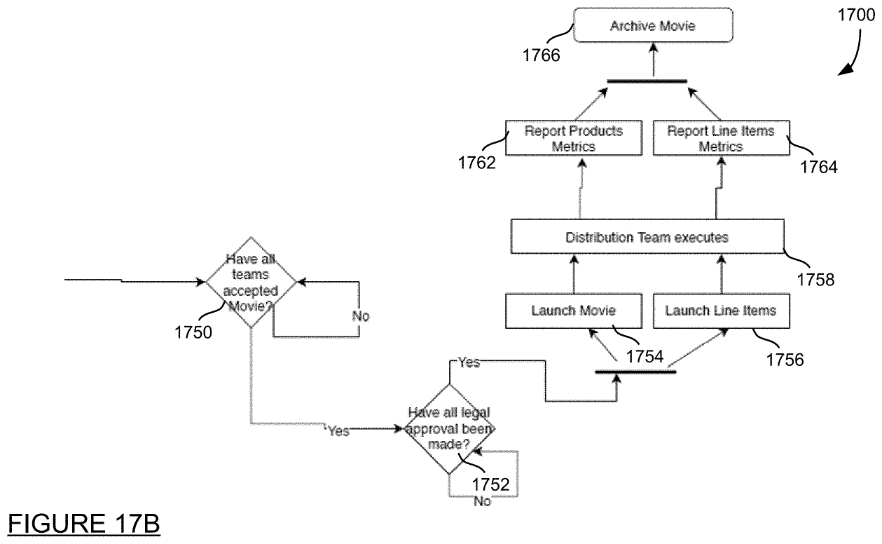

FIGS. 17A-11B are a method for a movie generation workflow. A campaign is defined at step 1710 and organizations are invited at step 1712. A determination is made as to whether all organizations have accepted the invite at step 1714. If not all organizations have accepted the invite, the method of FIG. 17 remains at step 1714. If all organizations have accepted the invite, then a media team and production team are assembled in parallel at steps 1716 and 1718, respectively. Distribution teams and talent teams are also assembled in parallel at steps 1720 and 1722. After assembling the media team, a media plan is created at step 1724 and then edited at step 1726. A determination is made as to whether all parties have accepted the media plan at step 1728. If all parties have not accepted the plan, the method of FIG. 17 returns to step 1726 with the media plan is further edited. If the parties have accepted the media plan, line items may be purchased at step 1730 and activated at step 1732. The media may be collaborated upon at step 1734.

A determination is made as to whether the line items have been accepted at step 1736. If the line items have not been accepted, the media is collaborated on further at step 1734. If the line items have been accepted, the line items are launched at step 1738 and line item metrics are reported at step 1740. The method of FIG. 17A then continues to step 1748.

After assembling production team, a distribution team, and a talent team, collaboration on media is performed at step 1744. A determination is made as to whether the movie is complete at step 1742. If the movie is not complete, media collaboration continues at step 1744. Once the movie is complete, all teams can prepare the movie for launch at step 1748 and the media plan team prepares line items for launch at step 1746. The method of FIG. 17A then continues to step 1750 in FIG. 17B.

A determination is made as to whether all teams have accepted the movie at step 1750. If not, the method of FIG. 17B remains at step 1750. Once all teams have accepted the movie, a determination is made as to whether all legal approvals have been made at step 1752. If all legal approval has not been made, the method of FIG. 17B remains at step 1752. Once all legal approval has been made, the movie is launched at step 1754 and line items are launched at step 1756. After launching line items, a distribution team executes at step 1758. Line item metrics are then reported at step 1764 and product metrics are reported at step 1762. After reporting metrics, the movie is archived at step 1766.

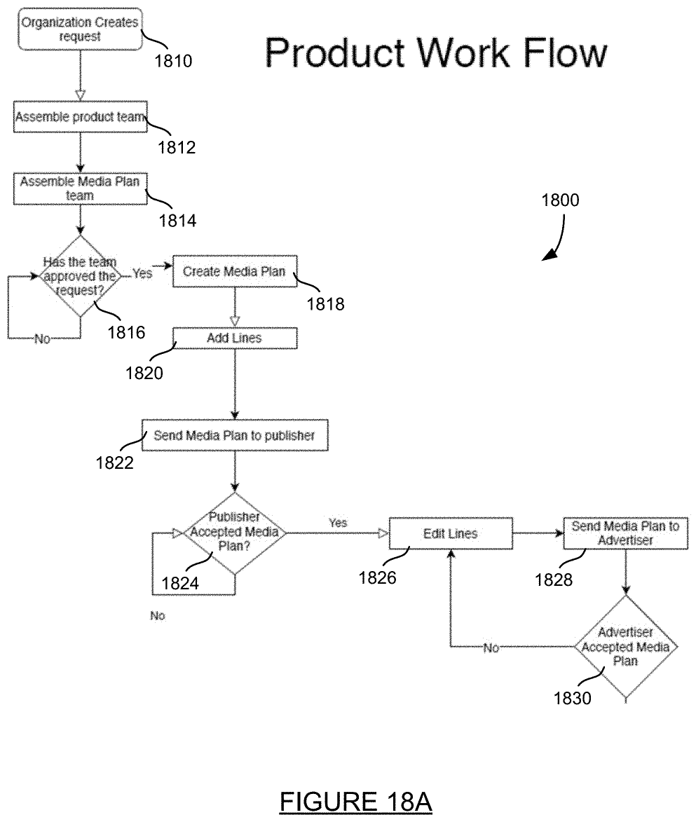

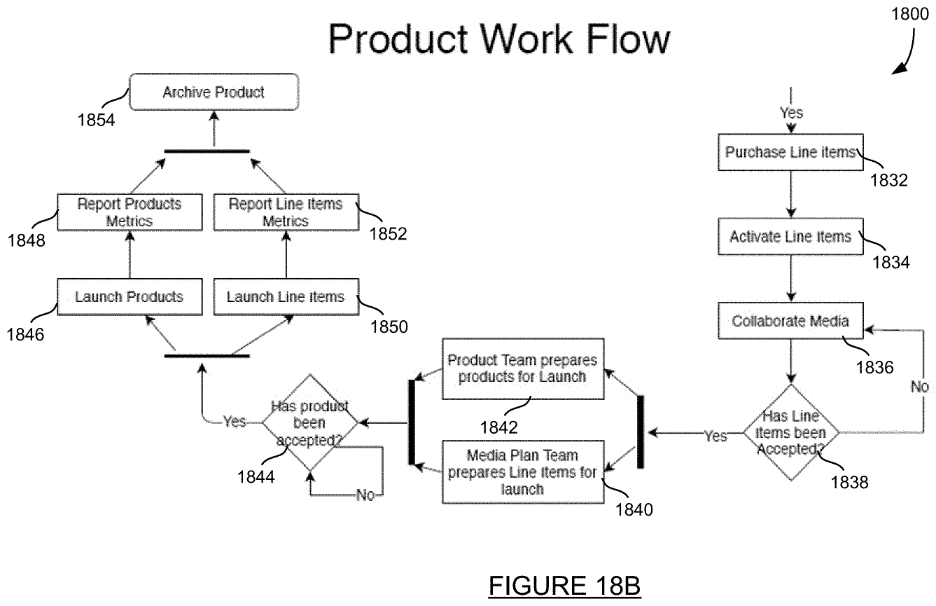

FIGS. 18A-12B are a method for a product workflow. An organization creates a request at step 1810. The product team is assembled at step 1812. A media plan team is assembled at step 1814. A determination is then made as whether the team approves requests at step 1816. If the team does not approve the request, the method of FIG. 18 remains at step 1816. If the team does approve the request, a media plan is created at step 1818 and line items are added to the media plan at step 1820. A media plan is then sent to a publisher at step 1822. A determination is made as to whether the publisher accepts the media plan at step 1824. If a publisher does not accept the media plan, the method of FIG. 18 remains at step 1824. Once the publisher does accept the media plan, line items are edited at step 1826 and a media plan is sent to an advertiser at step 1828. A determination is then made as whether the advertiser accepts the media plan at step 1830. If the advertiser does not accept the media plan, lines are edited further at step 1826. If the advertiser does accept the media plan, the method of FIG. 18A continues to step 1832 of the method of FIG. 18B.

Line items are purchased at step 1832 and activated at step 1834. Media is collaborated on at step 1836 and a determination is made as to whether line items have been accepted at step 1838. If the line items have not been accepted, the method of FIG. 18B then returns to step 1836. If the line items have been accepted, a product team prepares products for launch at step 1842 and a media plan team prepares line items for launch at step 1840. A determination is then made as to whether a product has been accepted at step 1844. If the product is not accepted, the method of FIG. 18B remains at step 1844. If the product has been accepted, line items are launched at step 1850 and line item metrics are reported at step 1852, while products are launched at step 1846 and product metrics are reported at step 1848. After reporting metrics, the product is archived at step 1854.

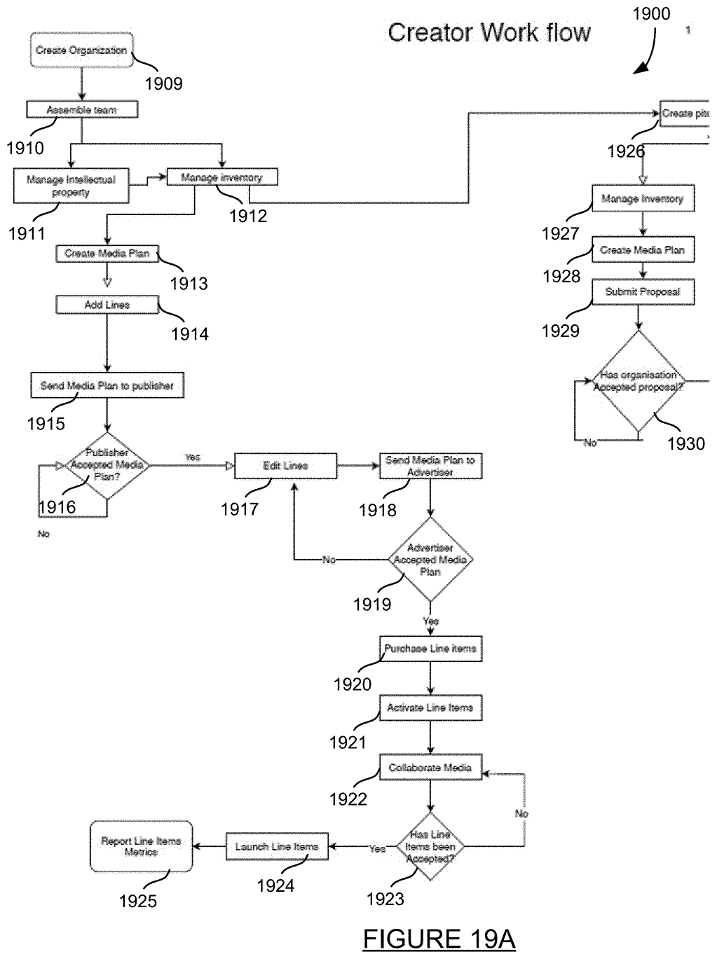

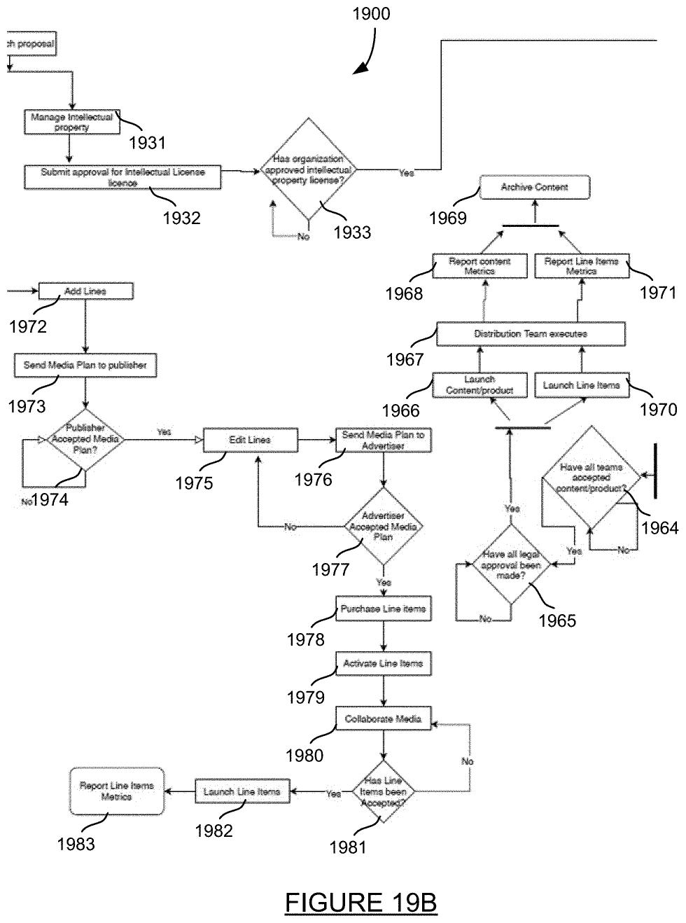

FIGS. 19A-19C are a method for a creator workflow. An organization is created at step 1909. A team may be assembled at step 1910. IP may be managed at step 1911 and inventory may be managed at step 1912. After managing inventory, the media plan may be created at step 1913 and lines may be added to the new media plan at step 1914. A media plan may be sent to a publisher at step 1915. A determination may then be made as to whether the publisher accepts the media plan at step 1916. The publisher does not accept the media plan, the method of FIG. 19 remains at step 1916. Once the publisher does accept the media plan, lines may be edited at step 1917 and the media plan may be sent to an advertiser at step 1918. A determination may be made as to whether an advertiser accepts the media plan at step 1919. If the advertiser does not accept the media plan, the method of FIG. 19 returns to step 1917 where the line items may be edited. Once an advertiser does accept the media plan, line items may be purchased at step 1920 and activated at step 1921. Media collaboration may occur at step 1922, and a determination is made as to whether the line items have been accepted at step 1923. If the line items have not been accepted, the method of FIG. 19A returns to step 1922. Once the line items have been accepted, line items may be launched at step 1924 and a line item metrics may be reported at step 1925.

Returning to a user managing inventory at step 1912, a pitch proposal may be created at step 1926. After creating the pitch proposal, inventory may be managed at step 1927. The media plan may be created at step 1928 and the proposal may be submitted at step 1929. A determination may then be made as to whether the organization has accepted the proposal at step 1930. If the organization has not accepted the proposal, the method remains at step 1930. If the organization does accept the proposal, the method continues to step 1972 of FIG. 19B.

Line items are added at step 1972. A media plan is sent to a publisher at step 1973. A determination is then made as to whether the publisher accepts the media plan at step 1974. If the publisher does not accept the media plan, the method of 19B remains at step 1974. Once the publisher does accept the media plan, line items are edited at step 1975 and the media plan is sent to an advertiser at step 1976. A determination is made as to whether an advertiser accepts the media plan at step 1977. If the advertiser does not accept the plan, the method of FIG. 19B returns to step 1975. If the advertiser does accept the plan, line items may be purchased at step 1978 and activated at step 1979, and media collaboration occurs at step 1980. A determination is then made as whether the line items have been accepted at step 1981. If the line items have not been accepted, the method returns to step 1980. If the line items are accepted, the line items are launched at step 1982 and line item metrics are reported at step 1983.

Returning to creating a pitch proposal at step 1926, IP may be managed at step 1931. The approval for an IP license may be submitted at step 1932. A determination is then made as to whether the organization approved the IP license at step 1933. If the license is not approved, the method of FIG. 19B remains at step 1933. If the IP license is approved, the method of 19B proceeds to step 1934 of FIG. 19C.

Production and content are defined at step 1934. Organizations are invited at step 1945, and a determination is made as to whether all organizations have accepted invites at step 1946. If not all organizations have accepted the invite, the method remains at step 1946. Once all organizations have accepted the invite, media teams may be assembled at step 1947, the production team is assembled at step 1948, the distribution team is assembled at step 1949, and a talent team is assembled at step 1950.

After creating a media team, the media plan is created at step 1951. The media plan is edited at step 1952. A determination as to whether all parties have accepted the media plan is made at step 1953. If not all the parties have accepted the plan, the method of FIG. 19C returns to step 1952. If all the parties have accepted the media plan, line items are purchased at step 1954 and line items are activated at step 1955. Media collaboration occurs at step 1956. A determination is then made as to whether the line items have been accepted at step 1957. If the line items have not been accepted, the method of FIG. 19C returns to step 1956. The line items have been accepted, line items are launched at step 1958, and line item metrics are reported at step 1959. The method then continues to step 1962 and 1961.

Returning to steps 1948-1950, once a production team, distribution team, and talent team are assembled, media is collaborated on at step 1963. A determination is made at step 1960 as to whether the content is complete. If the content is not complete, the method returns to step 1963 for additional collaboration. If the content is complete, then the media plan team can prepare line items for launch at step 1961 and all teams can prepare content and product for launch at step 1962. The method then continues to step 1964 of the method of in FIG. 19B.

A determination is made as whether all teams have accepted content and/or product at step 1964. If not all teams have accepted the content and/or product, the method remains at step 1964. If all teams have accepted the content and/or product, a determination is made as to whether all legal approval has been made at step 1965. If not all legal approval has been made, the method remains at step 1965. If all legal has been approved, then line items are launched at step 1970 and content and product are launched at step 1966. After launch, a distribution team executes at step 1967. Content metrics are reported at step 1968 and line item metrics are reported at step 1971, and the content is an archived at step 1969.

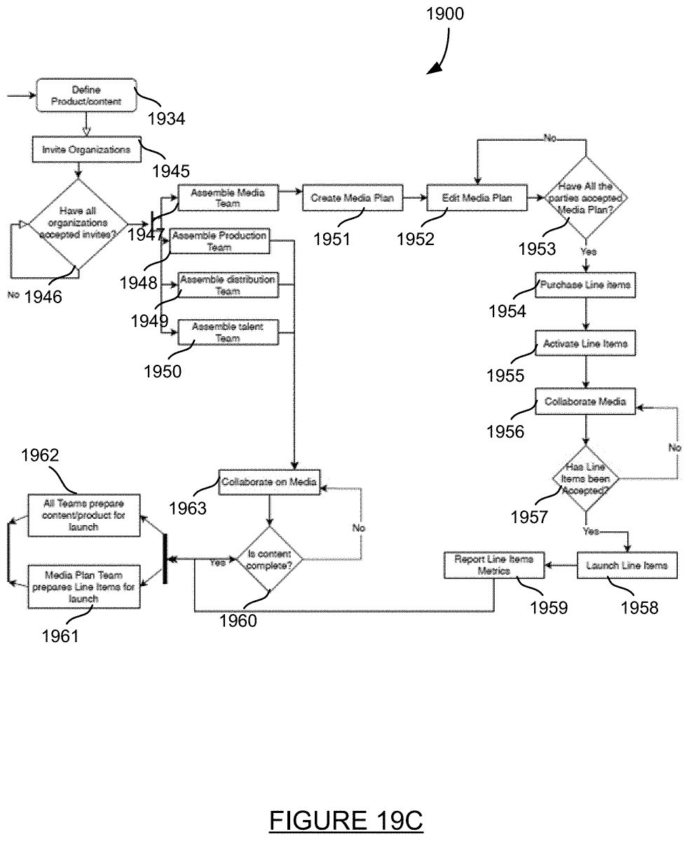

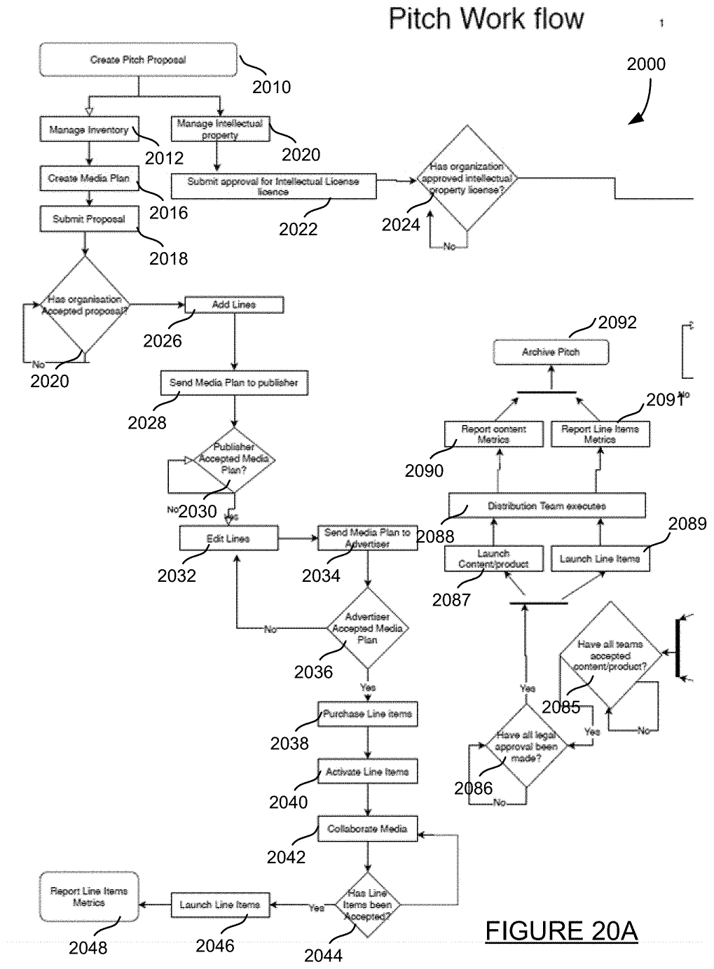

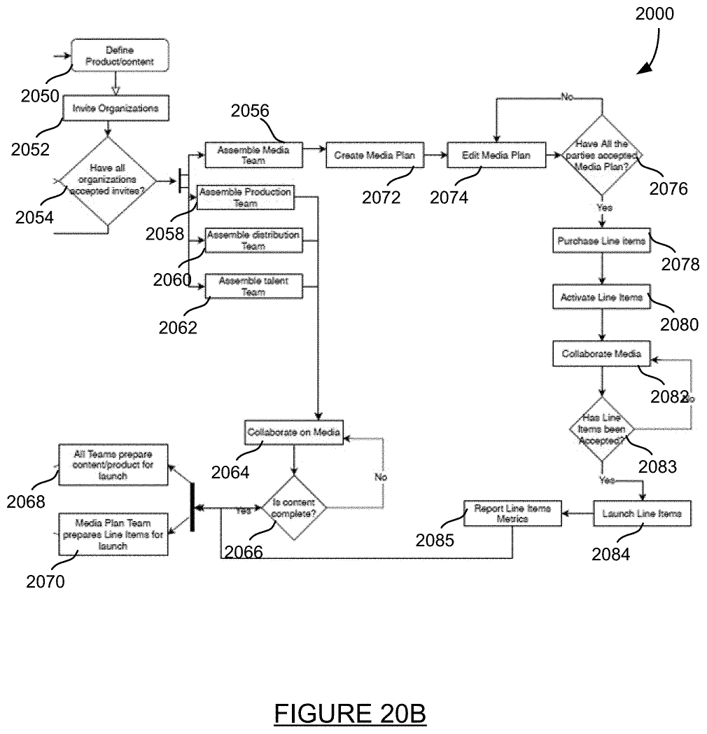

FIGS. 20A-14B are a method for a pitch workflow. A pitch proposal is created at step 2010. After creating a pitch, inventory can be managed at step 2012 and a media plan can be created at step 2016. The proposal can then be submitted at step 2018. A determination is made as to whether the organization accepts the proposal at step 2020. If the proposal is not accepted by the organization, the method of FIG. 20A remains at step 2020. Once the organization accepts the proposal, line items are added at step 2026 and the media plan may be sent to a publisher at step 2028. A determination is made as to whether a publisher accepts the media plan at step 2030. If the publisher does not accept the media plan, the method remains at step 2030. Once a publisher does accept the media plan, line items may be edited at step 2032 and the media plan can be sent to an advertiser at step 2034. A determination can be made as to whether the advertiser accepts the media plan at step 2036. If the advertiser does not accept the media plan, the method of FIG. 20A returns to step 2032 where line items can be further edited. Once an advertiser does accept the media plan, line items may be purchased at step 2038 and activated at step 2040. Media collaboration then occurs at step 2042. A determination is then made as to whether a line item has been accepted at step 2044. If the line item is not accepted, the method of 20A returns to step 2042. If the line item is accepted, line items are launched at step 2046 and line item metrics are reported at step 2048.

Returning to step 2010, after creating a pitch proposal, IP can be managed at step 2014. Approval for the IP license may be submitted at step 2022. A determination is made as to whether an organization has approved an IP license at step 2024. If the license is not approved, the method of FIG. 20A remains at step 2024. If the license is approved, the method continues to step 2050 of the method of FIG. 20B.

Product and/or content are defined at step 2050. Organizations may be invited at step 2052, and a determination is made as to whether all organizations have accepted the invite at step 2054. If all organizations have not accepted the invite, the method remains at step 2054. If the organizations have accepted the invite, a media team is assembled at step 2056, a production team is assembled at step 2058, the distribution team is assembled at step 2060, and a talent team is assembled at step 2062.

After assembling a media team, a media plan is created at step 2072. The media plan may be edited at step 2074. A determination is made as to whether all the parties have accepted the media plan at step 2076. If all parties have not accepted the media plan, the media plan may be edited at step 2074. If all parties have accepted the media plan, line items may be purchased at step 2078 and the line items may be activated at step 2080. Media collaboration may occur at step 2082 and a determination is made at step 2083 as to whether the line items have been accepted. If the line items have not been accepted, the method returns to step 2082. If line items have been accepted, line items may be launched at step 2084 and line item metrics may be reported at step 2085. The method then continues to step 2068 and 2070.

After assembling the production team, distribution team, and talent team, media collaboration may occur at step 2064. A determination is made as whether the content is complete at step 2066. If the content is not complete, the method returns to step 2064. If the content is complete, the teams prepare for content and/or product to launch at step 2068 and the media plan team prepares for line items to launch at step 2070. The method then continues to step 2085 of FIG. 20A.

A determination is made as whether all teams have accepted the content and/or product at step 2085. If not all teams have accepted, the method of FIG. 20A remains at step 2085. Once all teams have accepted, a determination is made as to whether all legal approval has been made at step 2086. If all legal approval has not been made, the method remains at step 2086. If all legal has been approved, then line items are launched at step 2089 and content and/or product is launched at step 2087. The distribution team then executes at step 2088. Content metrics are reported at step 2090, line item metrics are reported at step 2091, and the pitch is then archived at step 2092.

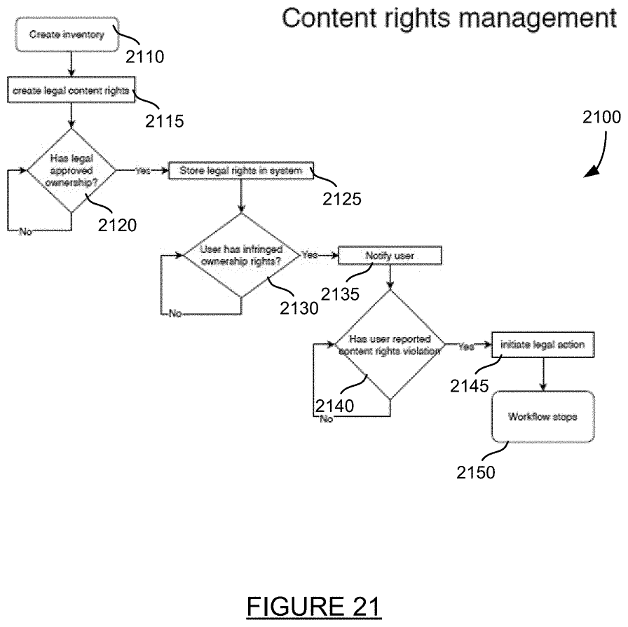

FIG. 21 is a method for content rights management workflow. Inventory is created at step 2110. Legal content rights are created at step 2115. A determination is then made as to whether legal has approved ownership at step 2120. If legal has not approved ownership, the method of FIG. 21 remains at step 2120. Once legal has approved ownership, legal rights are stored in the system at step 2125. A determination is then made as to whether a user has infringed the ownership rights at step 2130. If a user has not infringed the ownership rights, the method of FIG. 21 remains at step 2130. If a user has infringed the ownership rights, the user is notified step 2135.

A determination is made as to whether the user has reported a content rights violation at step 2140. If no violation is reported, the method of FIG. 21 remains at step 2140. If a user has reported a content rights violation, a legal action may be initiated at step 2145 and the workflow stops at step 2150.

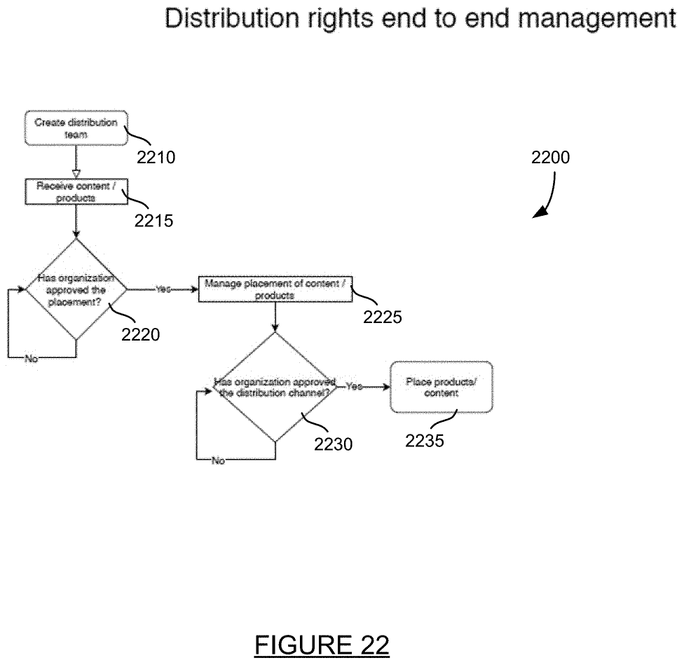

FIG. 22 is a method for distribution rights end to and management workflow. A distribution team is created at step 2210. Content and/or products may be received at step 2215. A determination is then made as to whether an organization has approved the placement at step 2220. If the organization has not approved placement, the method of FIG. 22 remains at step 2220. Once the organization does approve placement, the placement of the content and/or products is managed at step 2225. A determination is then made as to whether the organization has approved the distribution channel at step 2230. If the organization has not approved the distribution channel, the method of FIG. 22 remains at step 2230. Once the organization does approve the distribution channel, the products and/or content are placed at step 2235.

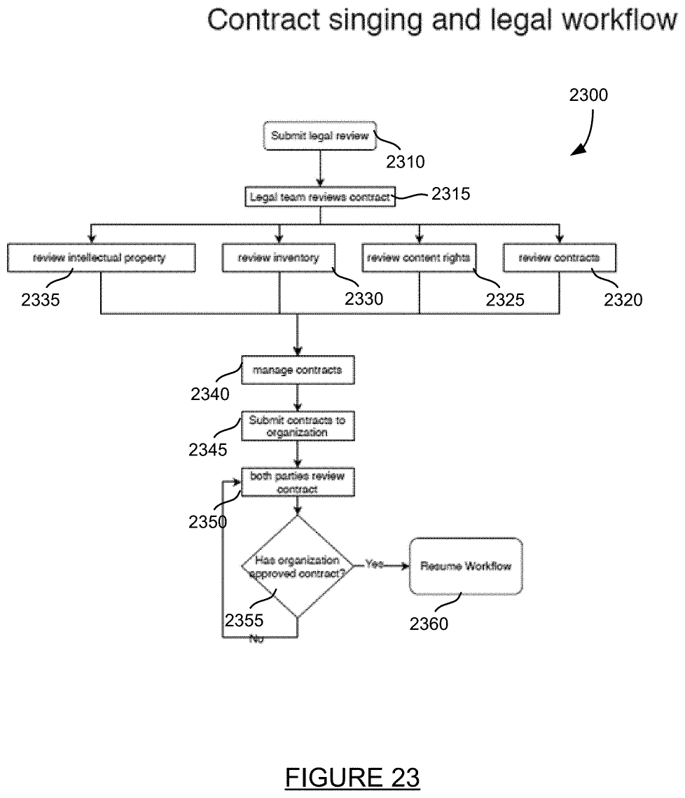

FIG. 23 is a method for a contract signing and legal workflow. Legal review is submitted at step 2310. The legal team reviews a contract at step 2315. Reviews can be made for intellectual property, inventory, content rights, and contracts in steps 2320-2335, respectively. After the review, contracts may be managed at step 2340, and the contract may be submitted to the organization at step 2345. Both parties may review the contracts at step 2350. A determination may be made as to whether the organization has approved the contract at step 2355. If the contracts are not approved, both parties may continue to review and revise the contracts at step 2350. If the organization has approved the contracts, workflow resumes at step 2360.

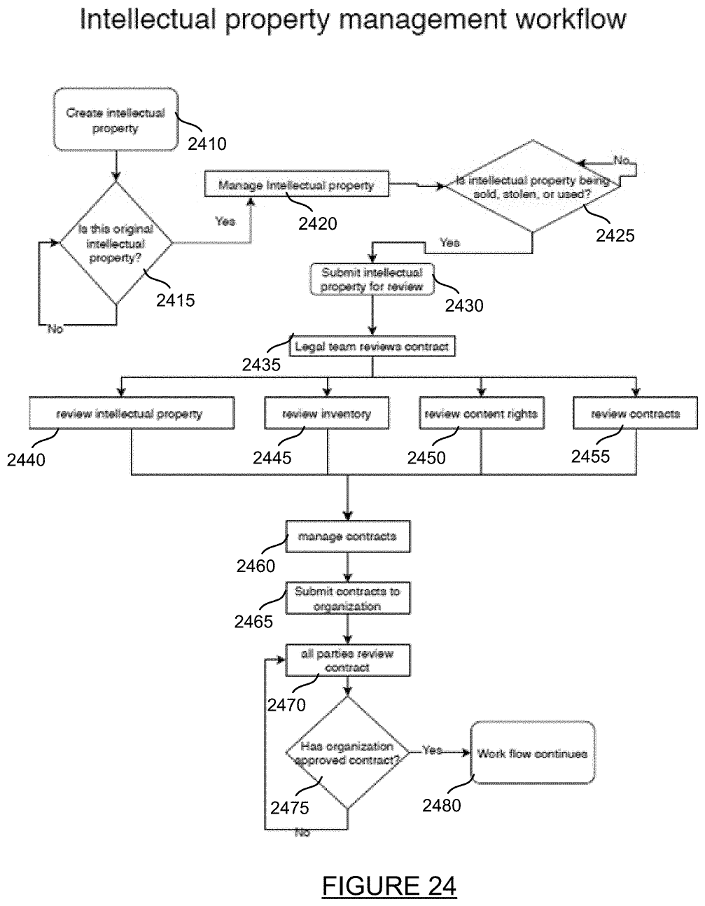

FIG. 24 is a method for an intellectual property management workflow. Intellectual property (IP) is created at step 2410. A determination is made as to whether the IP is original at step 2415. If the IP is not original, the method of FIG. 24 remains at step 2415. If the IP is original, the IP is managed at step 2420. A determination is then made as to whether the IP is being sold, stolen, or used at step 2425. If the IP rights are not being sold, stolen, or used, the method of FIG. 24 remains at step 2425. If the IP rights are being infringed, by being sold, stolen, or used without permission, the IP is then submitted for review at step 2430. The legal team reviews contracts at step 2435. Following review of the contracts, reviews may be made of the IP, inventory, content rights, and contracts at steps 2440-2455, respectively.

Contracts may be managed at step 2460, and the contracts may be submitted to the organization at step 2465. All parties may review the contract at step 2470. A determination is made as whether the organization has approved a contract at step 2475. If the organization has not approved the contracts, the method of FIG. 24 returns to step 2470. If the organization has approved contracts, then the workflow continues at step 2480.

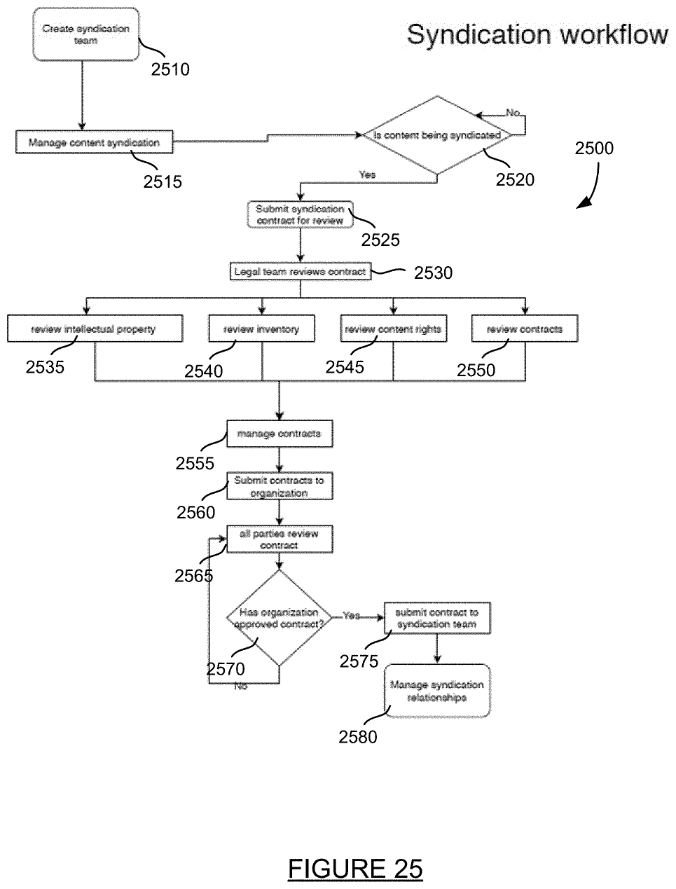

FIG. 25 is a method for syndication workflow. A syndication team is created at step 2510. Content syndication is then managed at step 2515. A determination is made as whether the content is being syndicated at step 2520. If the content is not being syndicated the method of FIG. 25 remains at step 2520. If the content is being syndicated, the syndication contract is submitted for review at step 2525 and the legal team reviews the contract at step 2530. Review may include review of IP, inventory, content rights, and contracts, at steps 2535-2550, respectively. After review, contracts may be managed at step 2555 and the contracts may be submitted to the organization at step 2560. All parties may review the contracts at step 2565. A determination is then made as to whether the organization has approved the contract at step 2570. If the organization has not approved the contract, the method of FIG. 25 returns to step 2565. If the organization has approved the contract, the contract may be submitted to the syndication team at step 2575 and the syndication relationships may be managed at step 2580.

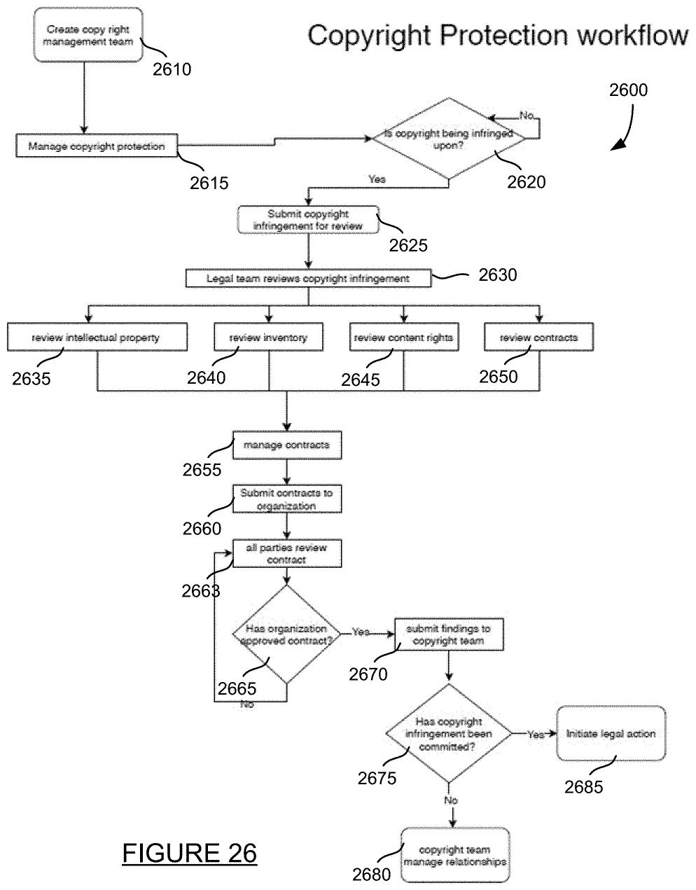

FIG. 26 is a method for a copyright protection workflow. A copyright management team may be created at step 2610. The copyright protection may be managed at step 2615. A determination is made as to whether a copyright is being infringed upon at step 2620. If no copyright is being infringed, the method of FIG. 26 remains at step 2620. If a copyright is being infringed, copyright infringement information is submitted for review at step 2625. The legal team reviews copyright infringement details at step 2630. Review may include review of IP, inventory, content rights, and contracts, at steps 2635-2650, respectively. After review, contracts may be managed at step 2655 and the contracts may be submitted to the organization at step 2660. All parties may review the contracts at step 2663.

A determination is made as to whether the organization has approved the contracts at step 2665. If the organization has not approved the contract, the method of FIG. 26 returns to step 2663 where the contracts may be further reviewed and possibly revised.

Once the organization does approve the contract, findings are submitted to the copyright team at step 2670. A determination is then made as to whether the copyright infringement has been committed at step 2675. If no infringement has been committed, the copyright team may manage relationships at step 2680. If the copyright infringement has been committed, legal action may be initiated at step 2685.

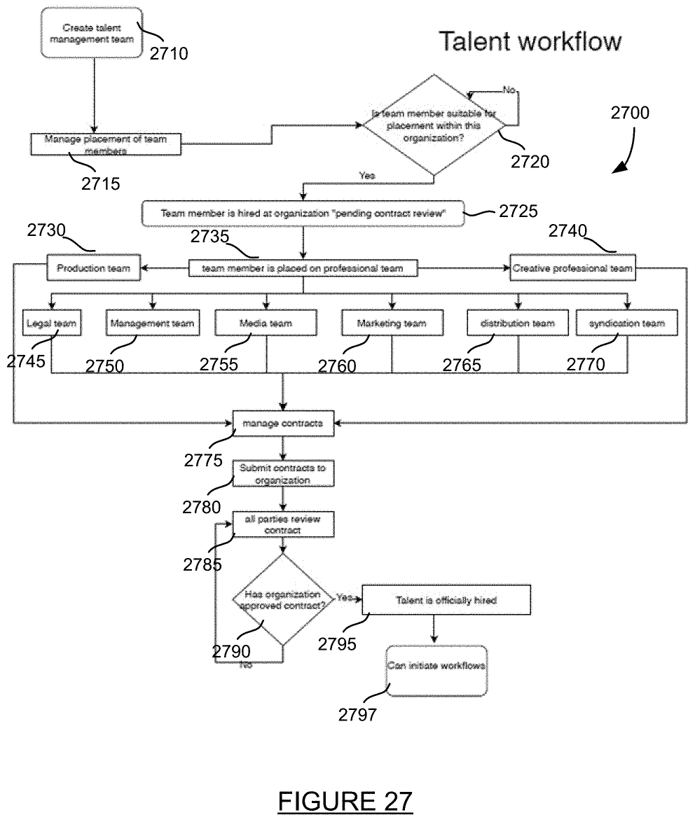

FIG. 27 is a method for a talent workflow. A talent management team is created at step 2710. The placement of team members is managed at step 2715. A determination is then made as to whether a team member is suitable for placement within the organization at step 2720. If a team member is not suitable for placement, the method of FIG. 27 remains at step 2720. If a team member is suitable for placement within the organization, the team member is hired at the organization pending contract review at step 2725. A team member may then be placed on a professional team at step 2735. The teams may include, for example, a production team 2730, a creative professional team 2740, a legal team 2745, a management team 2750, a media team 2755, a marketing team 2760, a distribution team 2765, and a syndication team 2770.

After being placed on a team, contracts may be managed at step 2775. Contracts may then be submitted to an organization at step 2780. All parties review the contract at step 2785, and a determination is made as to whether the organization has approved the contract at step 2790. If the contract has not been approved, the method of FIG. 27 returns to step 2785. If the contract has been approved, talent is officially hired at step 2795 and workflows may be initiated within the present system at step 2797.

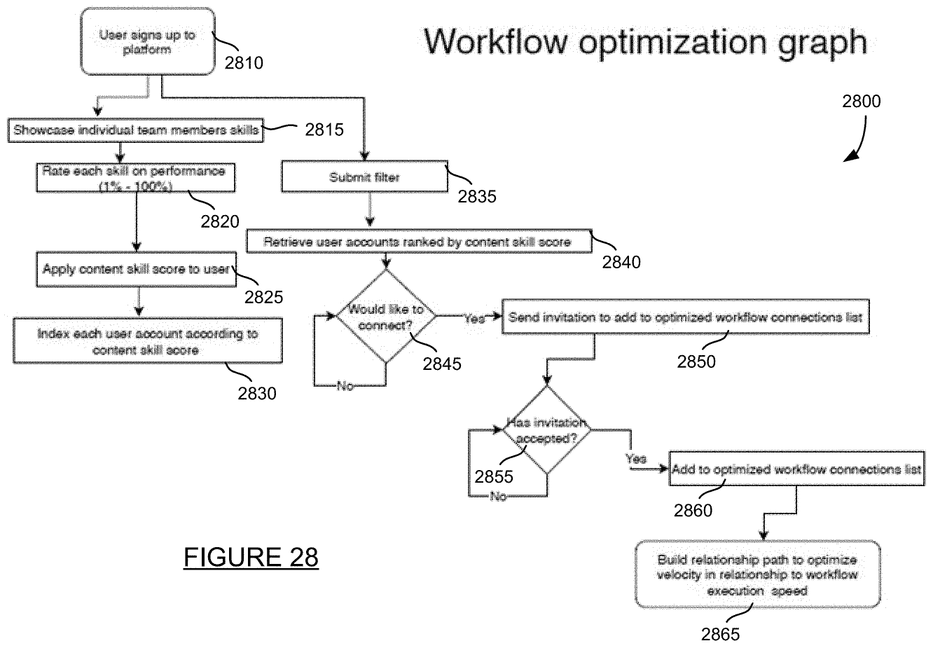

FIG. 28 is a method for a work optimization workflow. A user signs up for the platform at step 2810. Individual team members skills may be showcased at step 2815. Individual team member skills may be rated on a performance of 1% to 100% at step 2820. Content scale scores are applied to a user at step 2825. Each users' account may be indexed according to the content scale score at step 2830.

Additionally, after signing up for a platform, a filter may be submitted at step 2835. User accounts ranked by content skill score can be retrieved at step 2840. A determination may be made as to whether the user would like to connect at step 2845. If the user would not like to connect, the method of FIG. 28 remains at step 2845. If the user would like to connect, an invitation is added to the optimize workflow connections list at step 2850. A determination is made as to whether the invitation has been accepted at step 2855. If the invitation has not been accepted, the method remains at step 2855 until acceptance is received. Once the invitation has been accepted, the user is added to the optimize workflow connections list at step 2860. Relationship paths are then built to optimize velocity in relationship to the workflow execution speed at step 2865.

FIG. 29 is a screenshot of a dashboard for reporting return on advertisement spend. The dashboard screenshot of FIG. 29 illustrates resource allocation and cash allocation in a single dashboard. As money is earned in a market, the dashboard indicates how the products performed. The financial data is captured, provided to application server 160, and process for display in the dashboard by application 161 through APIs and remote data stores, json data reported to application 161, imported csv data, and optionally other data formats. Dashboard interface 2900 of FIG. 29 provides revenue for six areas of investment. The investment elements presented in the dashboard are brand partnership, featured sponsor, brand feature, a second brand feature, music snaps, and sponsor the music. For each feature for which money was invested, the return is illustrated by the bar graph extending from the particular feature. For example, brand partnership return on spend was approximately $160 million, while the music snaps return on spend was approximately $210 million. The interface also indicates that the customer is GM Motors and the marketing campaign is for “showcase our cars.”

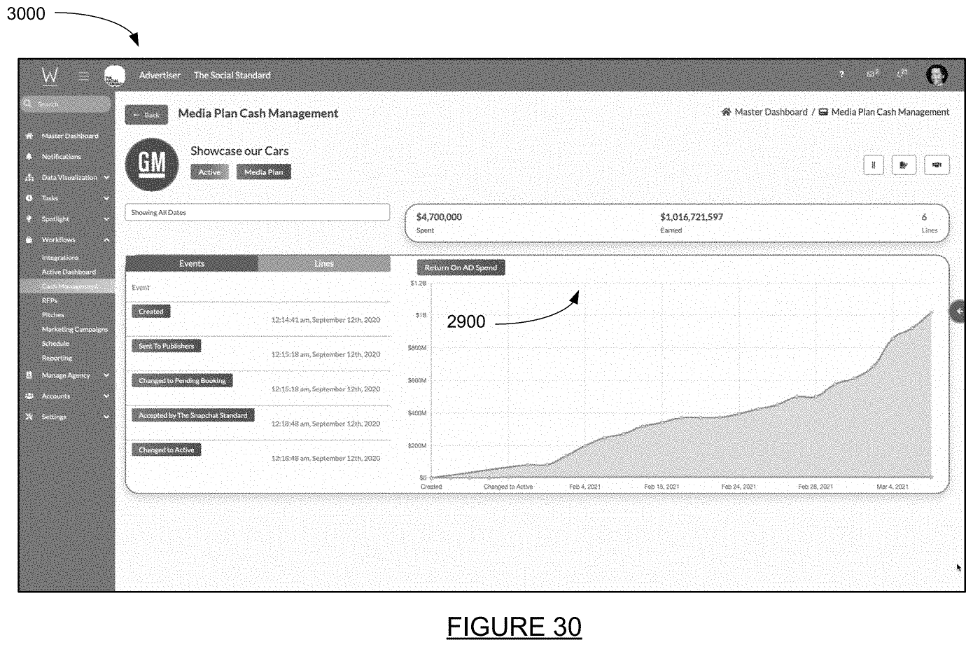

FIG. 30 is a screenshot of a dashboard for reporting media plan cash management. The dashboard 30000 of FIG. 30 is a brand insights dashboard, which indicates over time how cash moves within the market. The indications show cash movement from the time a marketing campaign was created to the current time or other selected time.

The dashboard 3000 of FIG. 30 includes money spent, money earned, events, lines, and a graphical display over time of the money spent and earned. As shown in the dashboard, the money spent was $4.7 million, in the money earned was over $1 billion. The events include a creation date, a center publisher state, the change to pending booking date, the date the Snapchat standard is accepted, and a date that a campaign was changed to active. The graphical display indicates the money earned over time, in particular from the creation date of Sep. 12, 2022 through March 2021.

FIG. 31 is a screenshot of a dashboard for reporting views for a particular media plan. The dashboard interface 3100 of FIG. 31 shows views per day as part of a media plan management interface. The views per day indicate the millions of views versus a particular date. Also provided are the estimated cost, estimated target views, the number of lines, and the target audience associated with the view. The dashboard of FIG. 31 provides information regarding how many people engage with a product in the marketing campaign over time.

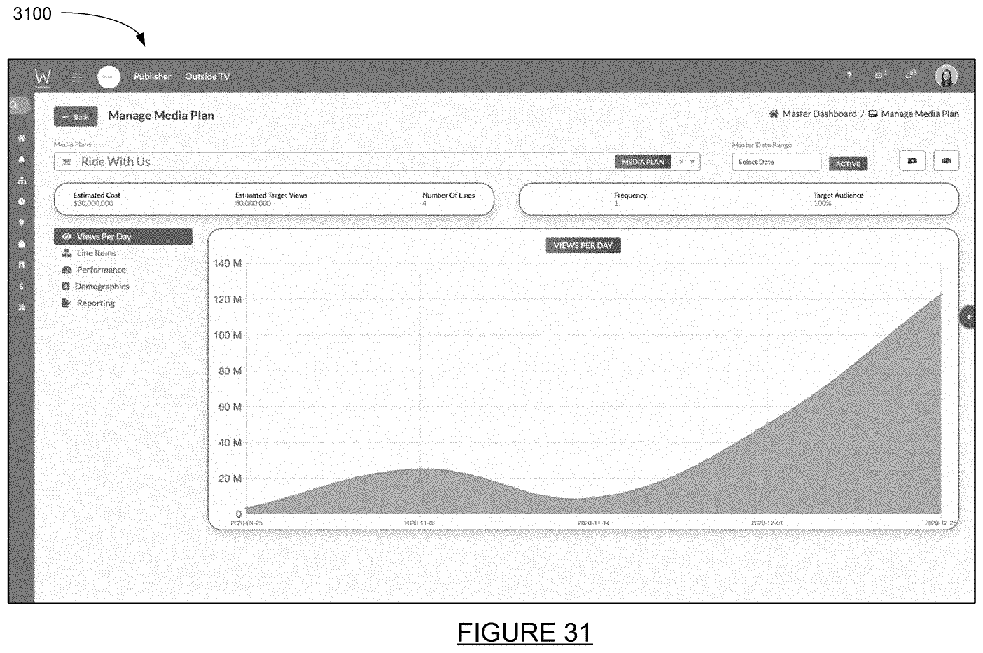

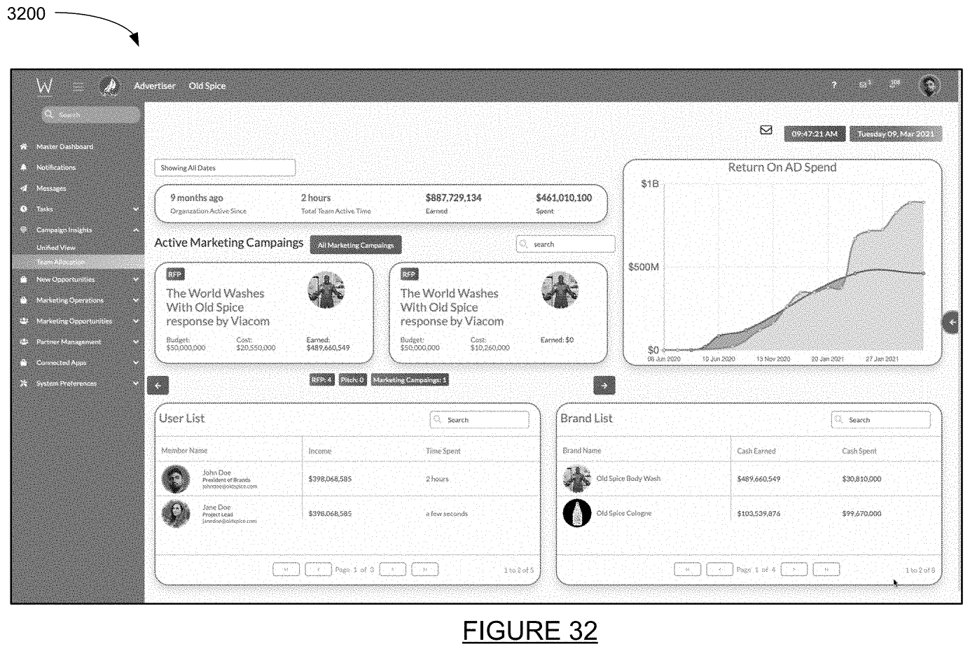

FIG. 32 is a screenshot of a dashboard for reporting advertiser cash management. The dashboard 3200 of FIG. 32 is a reporting dashboard for managing a media plan. In the dashboard 3200, resource allocation is provided next to capital allocation, so that a viewer can see what was spent versus what is earned. A viewer can also see the RFPs and a marketing campaign that a customer has participated in and what people are working during the period of the earnings.

On the dashboard, reported information includes activation time, total team active time, money earned, money spent, the return on spend, active marketing campaigns and request for proposals, user lists, and a brand list. As shown, the advertiser has to active marketing campaigns, one with 489 million earned, and another was zero earned. The user lists indicate a president of brands and a project lead, and indicates the income they are responsible for as was the time they have spent on a particular brand. The brand list indicates the two brands, the cash earned per brand, and the cash spent per brand.

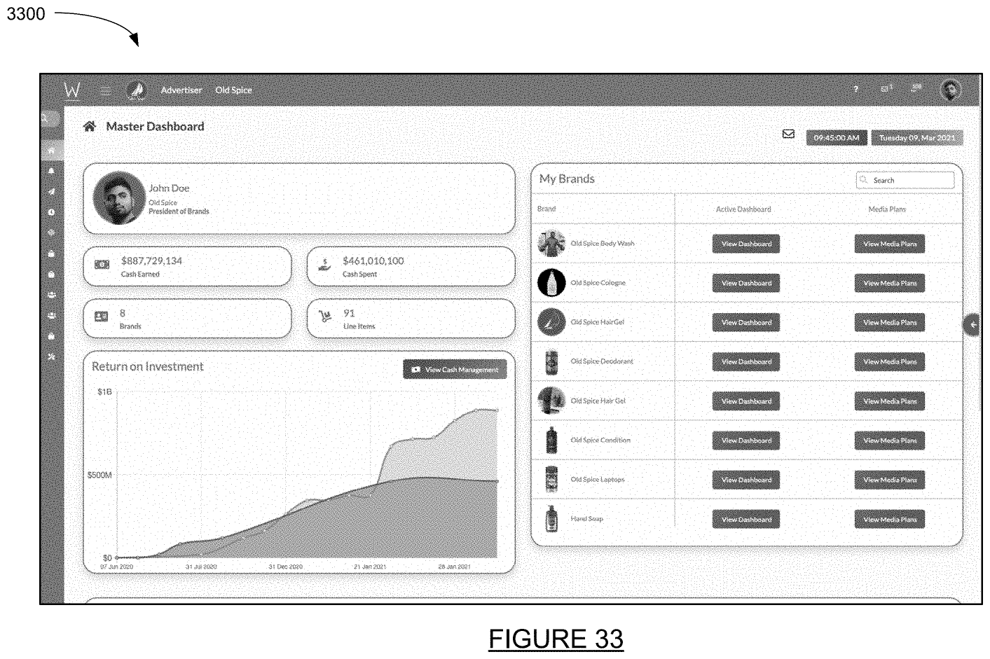

FIG. 33 is a screenshot of a master dashboard for an advertiser. The dashboard 3300 of FIG. 33 is a master dashboard for an advertiser. The advertiser master dashboard shows high-level user for the advertiser, cash earned, cash spent, the number of brands, line items, and return on investment information in graphical form. Also displayed are brand information for the brands, including the brand name itself as well as a logo, and links to an active dashboard and media plans for each brand.

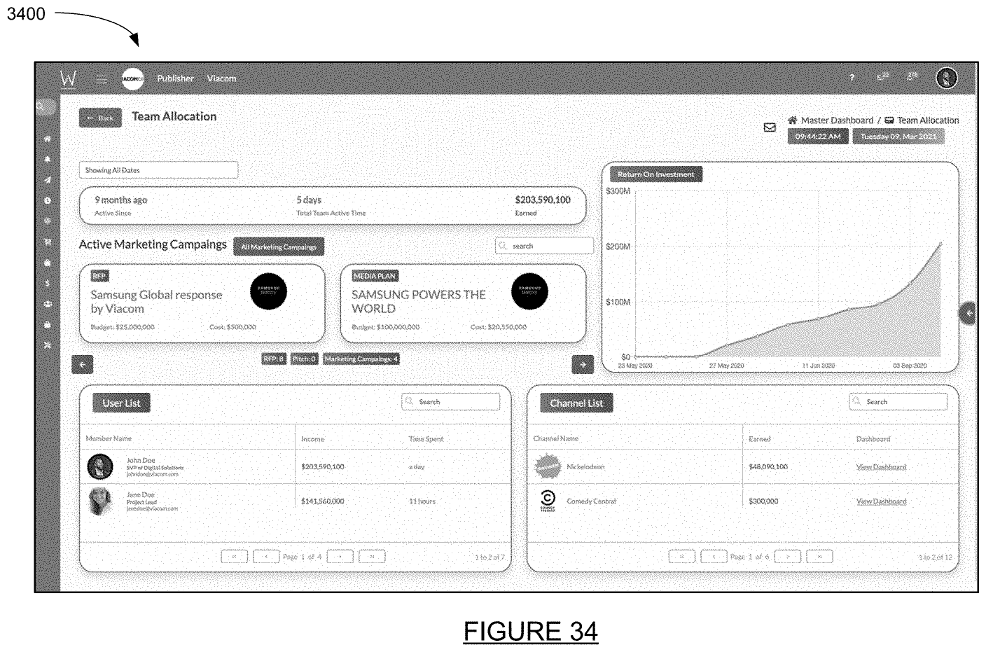

FIG. 34 is a screenshot of a dashboard for reporting publisher team allocation details. The dashboard 3400 of FIG. 34 illustrates a publisher side interface. The dashboard 3400 includes active marketing campaigns, a user lists, chalice, and a graphical representation of the return on investment. Also provided are the date from which the team allocation has been active, the total Tina active time, and the money earned. In this dashboard, the total money earned his $203 million, there are two marketing campaigns, one having an RFP for Samsung global response by Viacom and another having a media plan for Samsung powers the world, a user list with two users, a senior VP of digital solutions and a project lead, and a channel list that includes the Nickelodeon channel, the Comedy Central channel, the money earned for each channel, and links to dashboards for each channel.

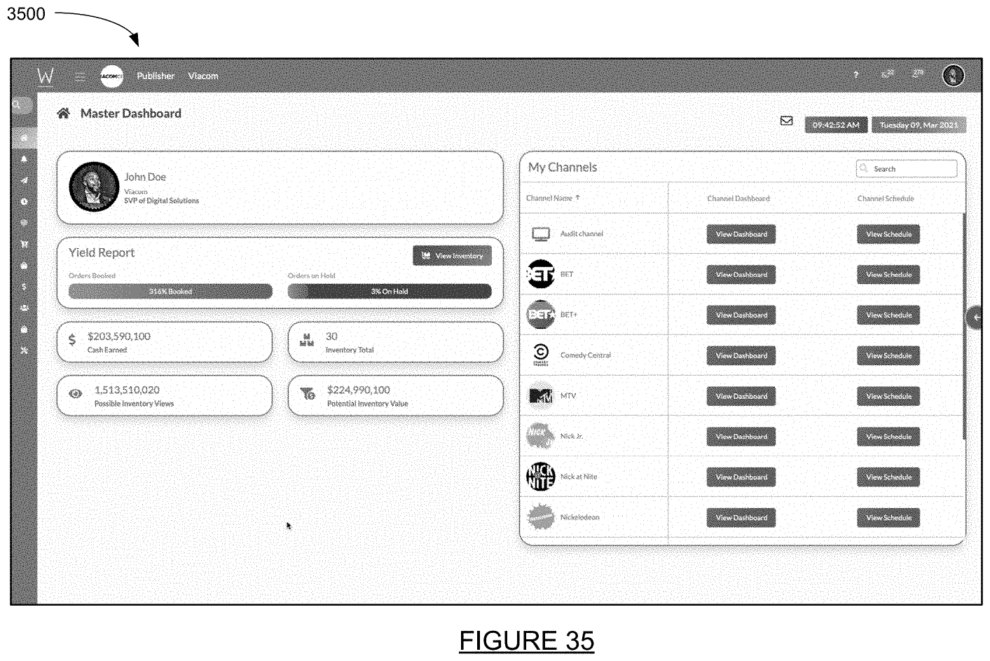

FIG. 35 is a screenshot of a master dashboard for a publisher. The publisher master dashboard 3500 of FIG. 35 presents a high level user, a yield report, the cash earned, inventory total, possible inventory views, potential inventory value, and a list of channels. In this case, the cash earned his 203 million, inventory total is 30 with over 1.5 billion possible inventory views, and the potential inventory value is $224 million.

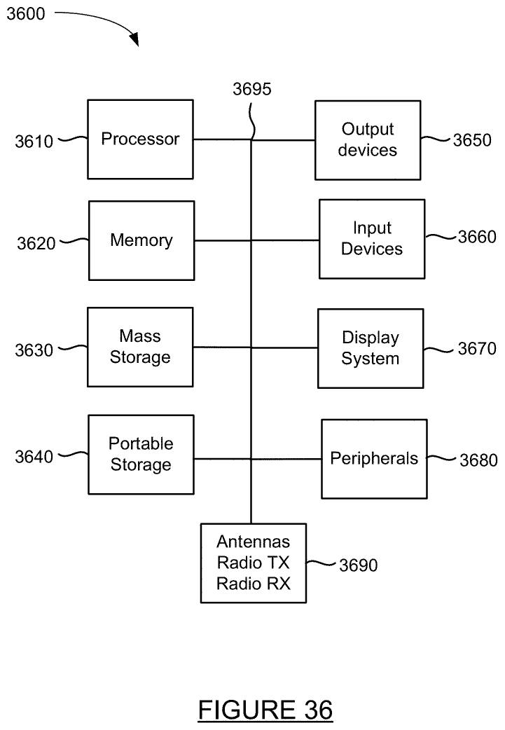

FIG. 36 is a block diagram of an environment for implementing the present technology. System 3600 of FIG. 36 may be implemented in the contexts of the likes of machines that implement computing devices 110-120 and 145-155, data stores. the 125-135, device 140, and application server 160. The computing system 3600 of FIG. 36 includes one or more processors 3610 and memory 3620. Main memory 3620 stores, in part, instructions and data for execution by processor 3610. Main memory 3620 can store the executable code when in operation. The system 3600 of FIG. 36 further includes a mass storage device 3630, portable storage medium drive(s) 3640, output devices 3650, user input devices 3660, a graphics display 3670, and peripheral devices 3680.

The components shown in FIG. 36 are depicted as being connected via a single bus 3690. However, the components may be connected through one or more data transport means. For example, processor unit 3610 and main memory 3620 may be connected via a local microprocessor bus, and the mass storage device 3630, peripheral device(s) 3680, portable storage device 3640, and display system 3670 may be connected via one or more input/output (I/O) buses.

Mass storage device 3630, which may be implemented with a magnetic disk drive, an optical disk drive, a flash drive, or other device, is a non-volatile storage device for storing data and instructions for use by processor unit 3610. Mass storage device 3630 can store the system software for implementing embodiments of the present invention for purposes of loading that software into main memory 3620.

Portable storage device 3640 operates in conjunction with a portable non-volatile storage medium, such as a floppy disk, compact disk or Digital video disc, USB drive, memory card or stick, or other portable or removable memory, to input and output data and code to and from the computer system 3600 of FIG. 36. The system software for implementing embodiments of the present invention may be stored on such a portable medium and input to the computer system 3600 via the portable storage device 3640.

Input devices 3660 provide a portion of a user interface. Input devices 3660 may include an alpha-numeric keypad, such as a keyboard, for inputting alpha-numeric and other information, a pointing device such as a mouse, a trackball, stylus, cursor direction keys, microphone, touchscreen, accelerometer, and other input devices. Additionally, the system 3600 as shown in FIG. 36 includes output devices 3650. Examples of suitable output devices include speakers, printers, network interfaces, and monitors.

Display system 3670 may include a liquid crystal display (LCD) or other suitable display device. Display system 3670 receives textual and graphical information and processes the information for output to the display device. Display system 3670 may also receive input as a touchscreen.

Peripherals 3680 may include any type of computer support device to add additional functionality to the computer system. For example, peripheral device(s) 3680 may include a modem or a router, printer, and other device.

The system of 3600 may also include, in some implementations, antennas, radio transmitters and radio receivers 3690. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 3600 of FIG. 36 are those typically found in computer systems that may be suitable for use with embodiments of the present invention and are intended to represent a broad category of such computer components that are well known in the art. Thus, the computer system 3600 of FIG. 36 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for providing automated advertisement content management, comprising:
retrieving, by a first server, a first advertising data associated with a first brand from a first remote data store, the first advertising data having a first format;
retrieving, by the first server, a second advertising data associated with a second brand from a second remote data store, the second advertising data having a second format;
retrieving, by the first server, a first publishing data associated with a first brand from a third remote data store, the first advertising data having a third format;
retrieving, by the first server, a second publishing data associated with a second brand from a fourth remote data store, the second advertising data having a fourth format;
automatically tagging, by the first server, the first advertising data, second advertising data, first publishing data, and second publishing data with a marketing campaign tag; and
automatically reporting the first advertising data, second advertising data, first publishing data, and second publishing data to one or more users associated with roles with permission to access information associated with the marketing campaign.

2. The method of claim 1, wherein the publishing data and advertising data retrieved from different data stores is associated with the marketing campaign and reported to users associated with an advertising role and users associated with a publishing role, wherein the users associated with an advertising role and users associated with a publishing role each have an account with the first server.

3. The method of claim 1, wherein reporting includes providing a dashboard through a remote device, the dashboard built from a template provided by the first server, the dashboard automatically populated with data from two or more of the first remote data store, the second remote data store, the third remote data store, and the fourth remote data store.

4. The method of claim 1, further comprising an application configured to coordinate advertising work flows and publishing workflow by the same server.

5. The method of claim 1, wherein an application program interface (API) is installed in two or more of the first remote data store, the second remote data store, the third remote data store, and the fourth remote data store, the API automatically formatting data at the respective remote data store and transmitting the formatted data to the first server.

6. The method of claim 1, wherein the first data, second data, third data and fourth data is stored at a fifth data store in communication with the first server, the first server automatically processing the data stored in the fifth data store and reporting the processed data to publishing users and advertising users.

7. A non-transitory computer readable storage medium having embodied thereon a program, the program being executable by a processor to provide automated advertisement content management, the method comprising:
retrieving, by a first server, a first advertising data associated with a first brand from a first remote data store, the first advertising data having a first format;
retrieving, by the first server, a second advertising data associated with a second brand from a second remote data store, the second advertising data having a second format;
retrieving, by the first server, a first publishing data associated with a first brand from a third remote data store, the first advertising data having a third format;
retrieving, by the first server, a second publishing data associated with a second brand from a fourth remote data store, the second advertising data having a fourth format;
automatically tagging, by the first server, the first advertising data, second advertising data, first publishing data, and second publishing data with a marketing campaign tag; and
automatically reporting the first advertising data, second advertising data, first publishing data, and second publishing data to one or more users associated with roles with permission to access information associated with the marketing campaign.

8. The non-transitory computer readable storage medium of claim 7, wherein the publishing data and advertising data retrieved from different data stores is associated with the marketing campaign and reported to users associated with an advertising role and users associated with a publishing role, wherein the users associated with an advertising role and users associated with a publishing role each have an account with the first server.

9. The non-transitory computer readable storage medium of claim 7, wherein reporting includes providing a dashboard through a remote device, the dashboard built from a template provided by the first server, the dashboard automatically populated with data from two or more of the first remote data store, the second remote data store, the third remote data store, and the fourth remote data store.

10. The non-transitory computer readable storage medium of claim 7, the method further comprising an application configured to coordinate advertising work flows and publishing workflow by the same server.

11. The non-transitory computer readable storage medium of claim 7, wherein an application program interface (API) is installed in two or more of the first remote data store, the second remote data store, the third remote data store, and the fourth remote data store, the API automatically formatting data at the respective remote data store and transmitting the formatted data to the first server.

12. The non-transitory computer readable storage medium of claim 7, wherein the first data, second data, third data and fourth data is stored at a fifth data store in communication with the first server, the first server automatically processing the data stored in the fifth data store and reporting the processed data to publishing users and advertising users.

13. A system for automated advertisement content management, comprising:
a server including a memory and a processor; and
one or more modules stored in the memory and executed by the processor to retrieving, by a first server, a first advertising data associated with a first brand from a first remote data store, the first advertising data having a first format, retrieve, by the first server, a second advertising data associated with a second brand from a second remote data store, the second advertising data having a second format, retrieve, by the first server, a first publishing data associated with a first brand from a third remote data store, the first advertising data having a third format, retrieve, by the first server, a second publishing data associated with a second brand from a fourth remote data store, the second advertising data having a fourth format, automatically tag, by the first server, the first advertising data, second advertising data, first publishing data, and second publishing data with a marketing campaign tag, and automatically report the first advertising data, second advertising data, first publishing data, and second publishing data to one or more users associated with roles with permission to access information associated with the marketing campaign.

14. The system of claim 13, wherein the publishing data and advertising data retrieved from different data stores is associated with the marketing campaign and reported to users associated with an advertising role and users associated with a publishing role, wherein the users associated with an advertising role and users associated with a publishing role each have an account with the first server.

15. The system of claim 13, wherein reporting includes providing a dashboard through a remote device, the dashboard built from a template provided by the first server, the dashboard automatically populated with data from two or more of the first remote data store, the second remote data store, the third remote data store, and the fourth remote data store.

16. The system of claim 13, the modules further executable to coordinate advertising work flows and publishing workflow by the same server.

17. The system of claim 13, wherein an application program interface (API) is installed in two or more of the first remote data store, the second remote data store, the third remote data store, and the fourth remote data store, the API automatically formatting data at the respective remote data store and transmitting the formatted data to the first server.

18. The system of claim 13, wherein the first data, second data, third data and fourth data is stored at a fifth data store in communication with the first server, the first server automatically processing the data stored in the fifth data store and reporting the processed data to publishing users and advertising users.
